(19) United States
(12) Patent Application Publication
(10) Pub. No.: US 2025/0349950 A1
(43) Pub. Date: Nov. 13, 2025

(54) SEALED ELECTROCHEMICAL CELLS AND ELECTROCHEMICAL CELL STACKS

(71) Applicant: 24M Technologies, Inc., Cambridge, MA (US)

(72) Inventors: Naoki OTA, Lexington, MA (US); Junzheng CHEN, Concord, MA (US); Junhua SONG, Sudbury, MA (US); Mark YOUNG, Lapel, IN (US); Frank Yongzhen FAN, Arlington, MA (US); Dhanya PUTHUSSERI, Millis, MA (US)

(21) Appl. No.: 19/197,378

(22) Filed: May 2, 2025

Related U.S. Application Data
(60) Provisional application No. 63/643,894, filed on May 7, 2024.

(51) Int. Cl. H01M 50/186; H01M 4/02; H01M 4/66; H01M 50/289; H01M 50/46; H01M 50/512

(52) U.S. Cl. CPC H01M 50/186; H01M 4/661; H01M 4/667; H01M 50/289; H01M 50/46; H01M 50/512; H01M 2004/027; H01M 2004/028

(57) ABSTRACT

Embodiments described herein relate to sealed electrochemical cells and multi-cells. An electrochemical cell includes a cathode disposed on a cathode current collector. The cathode current collector including a first layer disposed on the cathode and a second layer disposed on the first layer. The first layer includes a first material, and the second layer includes a second material different from the first material. The electrochemical cell further includes an anode disposed on an anode current collector. The anode current collector includes the second material. A separator is disposed between the cathode and the anode.

### CROSS-REFERENCE TO RELATED APPLICATIONS

This application claims priority to and the benefit of U.S. Provisional Patent Application No. 63/643,894, filed May 7, 2024, and titled, “SEALED ELECTROCHEMICAL CELLS AND ELECTROCHEMICAL CELL STACKS,” the disclosure of which is hereby incorporated by reference herein in its entirety.

### TECHNICAL FIELD

Embodiments described herein relate to sealed electrochemical cells and electrochemical cells stacks.

### BACKGROUND

While individual electrochemical cells, each with a single anode and cathode, can demonstrate superior performance metrics such as power density, capacity, and energy density, they may fall short in other areas. To overcome these limitations and achieve desired attributes, such as larger voltages or capacities, electrochemical cells can be disposed on top of each other, forming an electrochemical cell stack. The stacking can enhance certain performance metrics, but it can also introduce new challenges in terms of manufacturing and design. For example, metal pieces used in batteries (e.g., metal current collectors) may be exposed to vapor ingress during battery operation, increasing the risk of corrosion and potential battery failure. Galvanic corrosion, a destructive process, can degrade the cell stack's performance over time, reducing its efficiency and lifespan. In addition, cell stacks often include additional components for proper functioning, which can negatively impact their volumetric capacity. Dead volume, the non-reactive space in the cell stack, can affect electrolyte flow and current distribution, impacting performance.

### SUMMARY

In some embodiments, an electrochemical cell includes a cathode disposed on a cathode current collector, an anode disposed on an anode current collector and a separator disposed between the cathode and the anode. The cathode current collector includes a first layer disposed on the cathode and a second layer disposed on the first layer. The first layer includes a first material, and the second layer includes a second material different from the first material. In some embodiments, the anode current collector can include the second material.

In some embodiments, an electrochemical cell stack includes a first electrochemical cell and a second electrochemical cell electrically coupled to the first electrochemical cell. In some embodiments, the first electrochemical cell and the second electrochemical cell are the same or substantially similar to the electrochemical cell according to embodiments described above. In some embodiments, the second electrochemical cell can be disposed onto the first electrochemical cell such that the anode current collector of the first electrochemical cell can be disposed on the second layer of the cathode current collector of the second electrochemical cell.

In some embodiments, an electrochemical cell assembly includes a first electrochemical cell and a second electrochemical cell electrically coupled to the first electrochemical cell. The first electrochemical cell includes a first electrode disposed on a first current collector, a second electrode disposed on a first side of a second current collector, a third electrode disposed on a second side of the second current collector, and a fourth electrode disposed on a third current collector. The second side of the second current collector is opposite to the first side of the second current electrode. The first electrochemical cell further includes a first separator disposed between the first electrode and the second electrode, and a second separator disposed between the third electrode, and the fourth electrode. The first electrochemical cell includes a plurality of seal members, a respective one of the plurality of seal members being disposed around the first electrode, the second electrode, the third electrode, and the fourth electrode. The second electrochemical cell includes a first electrode disposed on a first current collector, a second electrode disposed on a first side of a second current collector, a third electrode disposed on a second side of the second current collector, and a fourth electrode disposed on a third current collector. The second side of the second current collector is opposite to the first side of the second current collector. The second electrochemical cell further includes a first separator disposed between the first electrode and the second electrode, and a second separator disposed between the third electrode, and the fourth electrode. The second electrochemical cell includes a plurality of seal members, a respective one of the plurality of seal members being disposed around the first electrode, the second electrode, the third electrode, and the fourth electrode.

### BRIEF DESCRIPTION OF THE DRAWINGS

FIG. 1 is a block diagram of an electrochemical cell stack, according to an embodiment.

FIG. 2 is a top perspective view of an electrochemical cell, according to an embodiment.

FIG. 3 is an exploded illustration of the electrochemical cell of FIG. 2.

FIG. 4 is a section view of the electrochemical cell of FIG. 2 taken along the line A-A in FIG. 2.

FIG. 5 is a section view of an electrochemical cell stack including a plurality of the electrochemical cells of FIGS. 2-4, according to an embodiment.

FIG. 6 is a block diagram of an electrochemical cell assembly, according to an embodiment.

FIG. 7 is a block diagram of an electrochemical cell assembly, according to an embodiment.

FIG. 8 is a block diagram of an electrochemical cell assembly, according to an embodiment.

FIG. 9 is a block diagram of an electrochemical cell assembly, according to an embodiment.

FIG. 10 is a block diagram of an electrochemical cell assembly, according to an embodiment.

FIG. 11 is a block diagram of an electrochemical cell system including a first electrochemical cell and a second electrochemical cell, according to an embodiment.

FIG. 12 is a block diagram of an electrochemical cell system including a first electrochemical cell and a second electrochemical cell coupled to each other in parallel, according to an embodiment.

FIG. 13 is a block diagram of an electrochemical cell system including a first electrochemical cell and a second electrochemical cell arranged anode-to-anode, according to an embodiment.

FIG. 14 shows a block diagram of an electrochemical cell stack, according to an embodiment.

FIG. 15 shows a block diagram of an electrochemical cell stack, according to an embodiment.

FIG. 16A shows a top view of the electrochemical system, as shown in FIG. 15; FIG. 16B shows a top view of the electrochemical system, as shown in FIG. 15.

FIGS. 17A and 17B show a top view of a different configuration of the electrochemical system, as shown in FIG. 14, according to an embodiment.

FIG. 18 is a schematic illustration of an electrochemical cell system including a first electrochemical cell and a second electrochemical cell arranged cathode-to-cathode, according to an embodiment.

### DETAILED DESCRIPTION

Embodiments described herein relate to electrochemical cells arranged in stacks, and methods of producing and operating the same. The electrochemical cell stacks can be formed by disposing multiple electrochemical cells on top of each other. According to multiple embodiments described herein, each electrochemical cell can include a seal member that extends around an outside perimeter of the electrochemical cell stack. In some embodiments, the electrochemical cell may include a cathode disposed on a cathode current collector, an anode disposed on an anode current collector, and a separator disposed between the cathode and the anode. In some embodiments, the cathode current collector can include a first layer and a second layer opposite to the first layer, the cathode being disposed on the first layer. The first layer includes a first material, and the second layer includes a second material different from the first material. In some embodiments, the seal member can aid isolating the cathode and/or the anode from exposure to an outside environment during operation. In some embodiments, the seal member may be coupled to peripheral edges of the cathode current collector and to the anode current collector such that the sealing is done in a closed loop. That is, an interior volume can be formed that isolates the cathode and the anode from the ambient or exterior environment. In some embodiments, a portion of the seal member that isolates the cathode may have a size that differs from a size of a seal member that isolates the anode.

In some embodiments, peripheral edges of the separator can extend at least partially into the sealing region and becomes physically in contact with the seal member. In some embodiments, the electrochemical cell stacks described herein can include at least one of an insulation layer or a heating layer disposed between adjacent electrochemical cells.

In some embodiments, for electrical pass-throughs, electrical tabs (e.g., strips of conductive metal) can be attached to the cell stacks (e.g., by ultrasonic weld, clamping fixture, tape, etc.). In some embodiments, the cathode current collectors can have tabs extending outside the electrochemical cell in a first axial direction, and anode current collectors can have tabs extending in a second axial direction opposite to, or the same as the first axial direction. In some embodiments, the electrochemical cell stack may be placed in a pouch and the tabs may extend outside the pouch. The electrochemical cell stacks described herein can be utilized to fabricate battery cells of various form factors, such as cylindrical or prismatic configurations.

Unused space is a significant problem faced with electrochemical cell stacks (e.g., stacks having large arrays of electrochemical cells). Therefore, the electrochemical stacks according to some embodiments described herein, are configured to minimize dead space within the cell stack. For example, a cathode and an anode can be of different sizes, in order to properly maximize material utilization. Additionally, a separator can be sized such that its length and width dimensions are greater than those of the anode and the cathode, such that peripheral edges of the separator can extend at least partially into the sealing region defined by the seal members, and contacts the seal member to prevent cross contamination between the anode and the cathode. By disposing electrochemical cells on top of each other in a cell stack, more electroactive material per unit volume can be realized. The seal member can also have longer length and/or width dimensions than the separator to aid in containment of the electroactive material. These extensions in the separator and the seal members can create unused space with no electroactive material therein. By folding the extended portions in the electrochemical cell stack, the dead space can be minimized. Examples of electrochemical cell stacks are described further in U.S. Pat. No. 10,181,587 (“the '587 patent”), filed Jun. 17, 2016, and entitled, “Single Pouch Battery Cells and Methods of Manufacture,” the entire disclosure of which is hereby incorporated by reference herein.

Some methods of arranging electrochemical cells in stacks and connecting the electrochemical cells include either (1) disposing an electrochemical cell in a casing (e.g., a pouch) and stacking such casings on each other, the casings serving as electrical connection points between electrochemical cells in a stack; or (2) arranging a plurality of electrochemical cells in a stack, connecting the plurality of electrochemical cells in series/parallel, and disposing the plurality of electrochemical cells in a single pouch. However, such electrochemical cell systems encounter certain challenges and do not often achieve a desired power and/or energy density while remaining compact in size, relatively easy to transport, and convenient and low-cost to manufacture.

Each electrochemical cell in the stack has an anode and a cathode, each connected to a current collector made of different metallic materials. When these metals come into contact in an environment where oxidation-inducing fluids are present, it can lead to damage and performance issues. This is particularly problematic in cell stacks connected in series and exposed to a vapor environment, where dissimilar metals like aluminum and copper can undergo galvanic corrosion. For example, some electrochemical cells coupled in series may include a copper anode current collector and an aluminum cathode current collector. Such electrochemical cells can be coupled in series with each other by stacking the electrochemical cells on the top of each other such that the copper anode current collector is disposed on the aluminum cathode current collector such that two current collectors physically contact each other. When such electrochemical cell assemblies are exposed to moisture, the difference in electrochemical potentials of the two current collectors because of them including different metals causes galvanic corrosion to occur in the current collectors. Over a period of time, the galvanic corrosion can cause pinholes to form through the current collectors, thereby creating flow paths for electrolytes included in the anode and the cathode of the adjacent electrochemical cells to leach into each other which is undesirable. For example, the electrolyte used in the anode of one electrochemical cell may be different from the electrolyte of the cathode of the adjacent electrochemical cell, and it may be desirable to keep them fluidically isolated from each other to maintain electrochemical cell performance. Therefore, the galvanic corrosion that may occur due to moisture ingress between the two different metallic material current collectors is undesirable.

One way to account for galvanic corrosion is to make the current collectors thicker. However, this increases thickness and mass of electrochemical cell stacks that is also undesirable. Additionally, the large volume occupied by these cell stacks can limit their use in certain applications with volume and power constraints. Therefore, it is desirable to minimize the stack's volume without reducing the number of cells.

In contrast, embodiments described herein related to sealed electrochemical cells and electrochemical cells stacks may provide one or more benefits including, for example: (1) reducing galvanic corrosion, thereby increasing the operational time and safety of the electrochemical cell; (2) reducing dead volume within the stack; (3) allowing higher total voltages (e.g., up to 500 V) to be achieved without significant increase in weight or volume of the electrochemical cell assemblies; (4) reducing component count at a system level (e.g., elimination of bus bars); (5) a reduction of manufacturing steps and components required in the system; (6) allowing assembly of the system in the field; (7) increasing portability of the system; (8) simplifying design thus reducing manufacturing time and cost; and (9) allowing implementation flexible voltage levels.

High voltage cells, modules, and packs are useful in high power applications such as in electric vehicle batteries and solar energy systems. High voltage cells provide benefits such as (1) a higher charge and discharge efficiency than low voltage batteries, thereby allowing support of higher load demands; (2) a high energy density; and (3) improved performance of the device, system, appliance, or machine that is being powered.

In some embodiments, electrodes described herein can include conventional solid electrodes. In some embodiments, the solid electrodes can include binders.

In some embodiments, electrodes described herein can include semi-solid electrodes. In some embodiments, the electrode materials described herein can be binderless or substantially free of binder. Semi-solid electrodes described herein can be made: (i) thicker (e.g., greater than 100 μm-up to 2,000 μm or even greater) than conventional electrodes due to the reduced tortuosity and higher electrical conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference herein in their entirety.

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the terms “energy density” and “volumetric energy density” refer to the amount of energy (e.g., MJ) stored in an electrochemical cell per unit volume (e.g., L) of the materials included for the electrochemical cell to operate such as, the electrodes, the separator, the electrolyte, and the current collectors. Specifically, the materials used for packaging the electrochemical cell are excluded from the calculation of volumetric energy density.

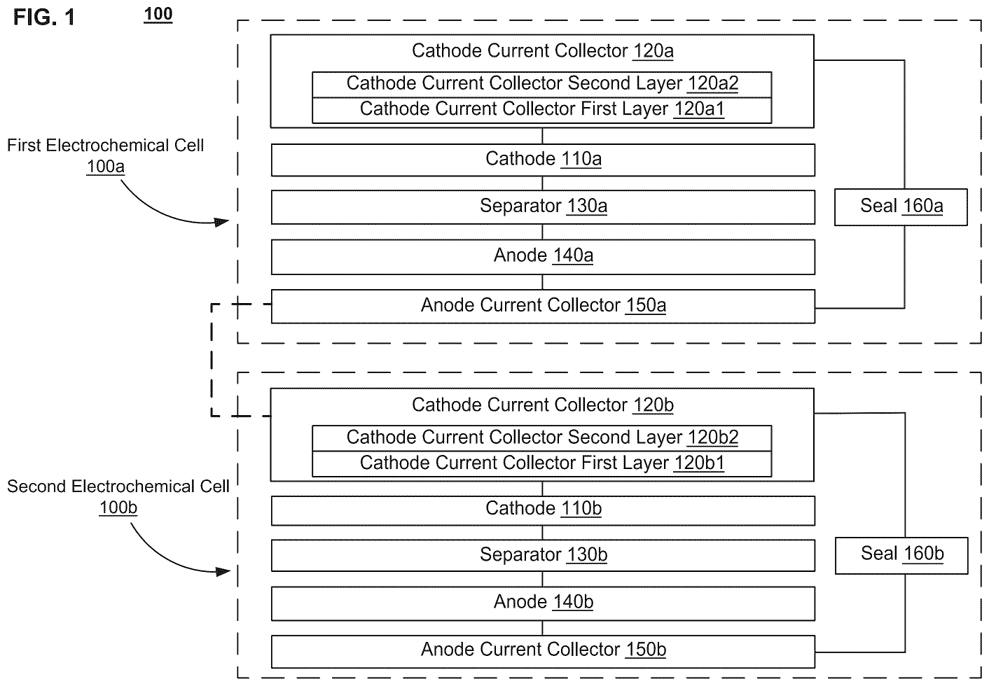

FIG. 1 is a block diagram of an electrochemical cell stack 100, according to an embodiment. The electrochemical cell stack 100 includes a first electrochemical cell 100a and a second electrochemical cell 100b electrically coupled to the first electrochemical cell 100a. The first electrochemical cell 100a includes a first cathode 110a disposed on a first cathode current collector 120a, a first anode 140a disposed on a first anode current collector 150a, and a first separator 130a disposed between the first cathode 110a and the second anode 140a. The first cathode current collector 120a includes a first layer 120a1 and a second layer 120a2 opposite to the first layer 120a1. The first cathode 110a is disposed on the first layer 120a1. In some embodiments, the first layer 120a1 includes a first material, and the second layer 120a2 includes a second material different from the first material. In some embodiments, the first anode current collector 150a may include or be formed from the second material.

The second electrochemical cell includes a second cathode 110b disposed on a second cathode current collector 120b, a second anode 140b disposed on a second anode current collector 150b, and a second separator 130b disposed between the second cathode 110b and the second anode 140b. The second cathode current collector 120b includes a first layer 120b1 and a second layer 120b2 opposite to the first layer 120b1. The second cathode 110b is disposed on the first layer 120b1. In some embodiments, the first layer 120b1 includes a first material, and the second layer 120b2 includes a second material different from the first material. In some embodiments, the second anode current collector 150b may include the second material.

The electrochemical cell stack 100 further includes a first seal member 160a (i.e., “seal 160a” in FIG. 1) that is disposed around a peripheral edge of the first electrochemical cell 100a, and a second seal member 160b (i.e., “seal 160b” in FIG. 1) that is disposed around a peripheral edge of the second electrochemical cell 100b.

In some embodiments, the second electrochemical cell 100b may be electrically coupled to the first electrochemical cell 100a. In some embodiments, the second electrochemical cell 100b can be disposed on the first electrochemical cell 100a such that the first anode current collector 150a of the first electrochemical cell 100a can be disposed on the second layer 120b2 of the second cathode current collector 120b.

In some embodiments, the first seal member 160a can be coupled to peripheral edges of the second layer 120a2 of the first cathode current collector 120a and the first anode current collector 150a. In some embodiments, the first seal member 160a can be physically in contact with peripheral edges of the second layer 120a2 of the first cathode current collector 120a and the first anode current collector 150a.

In some embodiments, the second seal member 160b can be coupled to peripheral edges of the second layer 120b2 of the second cathode current collector 120b and the second anode current collector 150b. the second seal member 160b can be physically in contact with peripheral edges of the second layer 120b2 of the second cathode current collector 120b and the second anode current collector 150b.

In some embodiments, the first and the second seal members 160a, 160b (collectively referred to as seal members 160) may include a first portion and a second portion. Portions, segments, or sections of the first and second portions may be coupled to each other to form a sealing region. For example, corresponding edges of the first portion and the second portion may be adhered or bonded to each other to form the sealing region. The first and second seal members 160a, 160b may be formed from any suitable material, for example, gaskets, sealing rings, adhesives (e.g., silicone, rubbers, polymers, etc.).

The seal members 160 can ensure that the different layers of the electrochemical cells 100a, 100b (collectively referred to as electrochemical cells 100a-b) remain in place and function effectively. The seal members 160 can also prevent any leakage of the materials (e.g., electrolyte) within the electrochemical cell stack 100, thereby enhancing the safety and longevity of the battery. In some embodiments, the seal members 160 can protect the cathode current collectors 120a, 120b (collectively referred to as cathode current collectors 120) from galvanic corrosion by preventing vapor ingress (e.g., moisture) from ambient or external environment. In some embodiments, the employment of seal members 160 could significantly contribute to the reduction of galvanic corrosion risks associated with the first layers 120a1, 120b1 of the cathode current collectors 120.

In some embodiments, the first and second portions of the seal members 160 could be situated on opposing sides of an imaginary axis, mirroring each other in both shape and orientation. That is, in some embodiments, the first and second portions of the seal members 160 may have a symmetrical configuration relative to each other, thereby preserving the integrity and operational efficiency of the components within the electrochemical cells 100a-b.

In some embodiments, the seal members 160 can be a part of a pouch. In some embodiments, the seal members 160 may not be a part of a pouch or an encasing material. In some embodiments, outer edges of the first portions of the seal members 160 can be folded at an angle of about 80 degrees to about 110 degrees with respect to the cathode 110. In some embodiments, outer edges of the second portions of the seal members 160 can be folded at an angle of about 80 degrees to about 110 degrees with respect to the anode 140.

In some embodiments, an anode tab (not shown) and a cathode tab (not shown) can extend beyond the seal members 160. In some embodiments, the anode tab and/or the cathode tab can be coupled to an anode tab and/or a cathode tab of one or more adjacent electrochemical cells in an electrochemical cell stack. In some embodiments, the electrochemical cells 100a-b can be the same or substantially similar to the electrochemical cells described in the '587 patent.

In some embodiments, the seal members 160 can contact the anode current collectors 150, the cathode current collectors 120, and/or the separator 130.

In some embodiments, the seal members 160 can be hermetically sealed to prevent the electrochemical cells 100a-b from exposure to the outside environment during operation.

Examples of materials suitable for forming the seal members 160 can include polyolefins, such as polyethylene, including high density polyethylene, low density polyethylene, linear low density polyethylene, and linear ultra-low density polyethylene, polypropylene, and polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadiene-styrene copolymers, and ethylene/propylene copolymers; acrylic polymers and copolymers; and combinations thereof. Mixtures or blends of any plastic and elastomeric materials such as polypropylene/polyethylene, polyurethane/polyolefin, polyurethane/polycarbonate, polyurethane/polyester, can also be used.

In some embodiments, peripheral edges of the cathode current collectors 120 and the anode current collectors 150a, 150b (collectively referred to as anode current collectors 150) do not extend into the sealing region.

In some embodiments, the first material includes aluminum and the second material includes copper. In some embodiments, current collector materials that form the cathode current collectors 120 and the anode current collectors 150 can be selected to be stable at the operating potentials of the positive and negative electrodes of electrochemical cells 100a and 100b. For example, in lithium systems, the first material can include at least one of aluminum, or aluminum coated with a conductive material that does not electrochemically dissolve at operating potentials of 2.5-5.0V with respect to Li/Li. In some embodiments, the conductive material may include at least one of platinum, gold, nickel, conductive metal oxides such as vanadium oxide, or carbon. In some embodiments, the first material can include at least one of aluminum, platinum, gold, nickel, conductive metal oxides, or carbon. In some embodiments, the second material may include copper, titanium, other metals that do not form alloys or intermetallic compounds with lithium, carbon, and/or coatings comprising such materials disposed on another conductor.

As shown in FIG. 1, the electrochemical cell stack 100 includes two electrochemical cells 100a and 100b (collectively referred to as electrochemical cells 100a-b). In some embodiments, the electrochemical cell stack 100 can include about 3, about 4, about 5, about 6, about 7, about 8, about 9, about 10, about 11, about 12, about 13, about 14, about 15, about 16, about 17, about 18, about 19, about 20, at least about 20, at least about 25, at least about 30, at least about 35, at least about 40, at least about 45, at least about 50, at least about 55, at least about 60, at least about 65, at least about 70, at least about 75, at least about 80, at least about 85, at least about 90, at least about 95, or at least about 100 electrochemical cells 100a-b, inclusive of all values and ranges therebetween. In some embodiments, at least two of the electrochemical cells 100a-b can be connected in parallel (not shown). In some embodiments, at least two of the electrochemical cells 100a-b can be coupled in series. In some embodiments, at least two of the electrochemical cells 100a-b can be coupled in series and at least two of the electrochemical cells 100a-b can be coupled in parallel. In some embodiments, one or more of the electrochemical cells 100a-b can include a single unit cell as shown in FIG. 1. In some embodiments, one or more of the electrochemical cells 100a-b can include a bi-cell (e.g., two unit cells sharing a current collector).

In some embodiments, a selection of many different battery properties can be combined into the electrochemical cell stack 100 in order to manipulate the performance properties of the electrochemical cell stack 100 as desired. In some embodiments, the electrochemical cell stack 100 can aid achieving a high total voltage while reducing galvanic corrosion and ultimately increasing the safety and performance of the battery. In some embodiments, the first electrochemical cell 100a and the second electrochemical cell 100b can be connected in series, and the voltage of the electrochemical cell stack 100 can be substantially equal to the sum of the individual cell voltages.

In some embodiments, the first anode 140a can have the same or substantially similar chemical composition to the second anode 140b. In some embodiments, the first anode 140a can be different from the second anode 140b. In some embodiments, the first anode 140a can be different from the second anode 140b in terms of chemical composition, thickness, density, porosity, and/or any other physicochemical and material properties.

In some embodiments, the first cathode 110a can have the same or substantially similar chemical composition to the second cathode 110b. In some embodiments, the first cathode 110a can be different from the second cathode 110b. In some embodiments, the first cathode 110a can be different from the second cathode 110b in terms of chemical composition, thickness, density, porosity, and/or any other physicochemical and material properties.

In some embodiments, the first electrochemical cell 100a and/or the second electrochemical cell 100b can be a high power density cell. In some embodiments, “high power density cell” can refer to an electrochemical cell with a cell specific power output of at least about 400 W/kg, at least about 450 W/kg, at least about 500 W/kg, at least about 550 W/kg, at least about 600 W/kg, or at least about 650 W/kg, or at least about 700 W/kg, inclusive of all values and ranges therebetween.

In some embodiments, the first electrochemical cell 100a and/or the second electrochemical cell 100b can be a high energy density cell. In some embodiments, “high energy density cell” can refer to an electrochemical cell with a cell specific energy density of at least about 250 W·h/kg when discharged at 1 C, at least about 300 W·h/kg when discharged at 1 C, at least about 350 W·h/kg when discharged at 1 C, at least about 400 W·h/kg when discharged at 1 C, or at least about 450 W·h/kg when discharged at 1 C, inclusive of all values and ranges therebetween In some embodiments, “high energy density cell” can refer to an electrochemical cell with a specific energy density of at least about 250 W·h/kg when discharged at C/2, at least about 300 W·h/kg when discharged at C/2, at least about 350 W·h/kg when discharged at C/2, at least about 400 W·h/kg when discharged at C/2, or at least about 450 W·h/kg when discharged at C/2, inclusive of all values and ranges therebetween. In some embodiments, “high energy density cell” can refer to an electrochemical cell with a specific energy density of at least about 250 W·h/kg when discharged at C/4, at least about 300 W·h/kg when discharged at C/4, at least about 350 W·h/kg when discharged at C/4, at least about 400 W·h/kg when discharged at C/4, or at least about 450 W·h/kg when discharged at C/4, inclusive of all values and ranges therebetween.

In some embodiments, the first electrochemical cell 100a and/or the second electrochemical cell 100b can be a high energy density cell with high heat production. In some embodiments, “cell with high heat production” can refer to an electrochemical cell, wherein at least about 20%, at least about 25%, at least about 30%, at least about 35%, at least about 40%, at least about 45%, or at least about 50% of the energy generated is lost as heat, inclusive of all values and ranges therebetween.

In some embodiments, the first electrochemical cell 100a and/or the second electrochemical cell 100b can be a high energy density cell that performs with low efficiency at low temperatures. In some embodiments, a “cell that performs with low efficiency at low temperatures” can refer to a cell that loses at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, at least about 99%, or about 100% of its discharge capacity when operated at −20° C., as compared to operation at room temperature, inclusive of all values and ranges therebetween.

In some embodiments, the first electrochemical cell 100a and/or the second electrochemical cell 100b can have high capacity retention. In some embodiments, “high capacity retention” can refer to an electrochemical cell that retains at least about 80%, at least about 85%, at least about 90%, at least about 95%, at least about 96%, at least about 97%, at least about 98%, or at least about 99% of its initial discharge capacity after 1,000 cycles, inclusive of all values and ranges therebetween.

In some embodiments, the first anode 140a and/or the second anode 140a (collectively referred to as anodes 140) can include at least one of graphite, lithium metal (Li), sodium metal (Na), silicon oxide (SiO), graphite, silicon, carbon, lithium-intercalated carbon, lithium nitrides, lithium alloys, lithium alloy forming compounds, or any other anode active material. In some embodiments, the lithium alloy forming compounds can include at least one of silicon, bismuth, boron, gallium, indium, zinc, tin, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon carbide, or silicon-graphite composite.

In some embodiments, the first cathode 110a and/or the second cathode 110b (collectively referred to as cathodes 110) can include at least one of lithium cobalt oxide (LCO), lithium nickel manganese cobalt oxide (NMC), lithium iron phosphate (LFP), or any other cathode active material.

In some embodiments, the first electrochemical cell 100a and/or the second electrochemical cell 100b can include a semi-solid electrode. In some embodiments, the first electrochemical cell 100a and/or the second electrochemical cell 100b can include conventional electrodes (e.g., solid electrodes with binders).

In some embodiments, the first electrochemical cell 100a and/or the second electrochemical cell 100b can include one or more electrolyte solutions. Electrolyte solutions can include at least one of ethylene carbonate (EC), gamma-butyrolactone (GBL), lithium bis(fluorosulfonyl) imide (LiFSI), trioctyl phosphate (TOP), propylene carbonate (PC), dimethoxyethane (DME), bis (trifluoromethanesulfonyl) imide (TSFI), or Li_{1.4}Al_{0.4}Ti_{1.6} (PO₄)₃ (LATP). Additional examples of active materials, conductive materials, and electrolyte solutions that can be incorporated in the first electrochemical cell 100a and/or the second electrochemical cell 100b are described in U.S. Pat. No. 9,484,569, entitled, “Electrochemical Slurry Compositions and Methods of Preparing the Same,” (“the '569 patent”) and in U.S. Pat. No. 9,437,864 entitled, “Asymmetric Battery Having a Semi-Solid Cathode and High Energy Density Anode,” registered Sep. 6, 2016 (“the '864 patent), the disclosures of which are hereby incorporated herein by reference in their entirety.

In some embodiments, peripheral edges of the first separator 130a, and the second separator 130b (collectively referred to as separators 130), can extend at least partially into the sealing region. In some embodiments, peripheral edges of the separators 130 can extend at least partially into the sealing region and physically contacts with the seal members 160.

As used herein, “separator” refers to any ion-permeable material or medium that provides electrical isolation between an anode and a cathode, while allowing charge carrying ions to pass therethrough. In some embodiments, the separators 130 may be in the form of a membrane, a film, a layer or a medium. In some embodiments, the separators 130 can include a conventional separator that allows charge carrying ions to pass therethrough, but do not provide chemical and/or fluidic isolation of the anode and cathode.

In some embodiments, the first separator 130a and/or the second separator 130b can include a selectively permeable membrane, such that the anodes 140 and cathodes 110 are fluidically and/or chemically isolated from each other. This can allow for independent optimization of the properties of each of the electrodes. Examples of electrochemical cells that include a separator with a selectively permeable membrane that can chemically and/or fluidically isolate the anode from the cathode while facilitating ion transfer during charge and discharge of the cell are described in U.S. Patent Publication No. 2019/0348705, entitled, “Electrochemical Cells Including Selectively Permeable Membranes, Systems and Methods of Manufacturing the Same,” filed Jan. 8, 2019 (“the '705 publication”), the disclosure of which is incorporated herein by reference in its entirety.

In some embodiments, the first electrochemical cell 100a can be disposed in a first pouch (not shown) and the second electrochemical cell 100b can be disposed in a second pouch (not shown). In some embodiments, the first electrochemical cell 100a and the second electrochemical cell 100b can be disposed in a single pouch.

In some embodiments, the first electrochemical cell 100a may be connected in series with the second electrochemical cell 100b by disposing the first electrochemical cell 100a on the second electrochemical cell 100b such that the first anode current collector 150a of the first electrochemical cell 100a is disposed on, and physically contacts the second current collector 120b of the second electrochemical cell 100b. As previously described, the first layer 120b1 of the second cathode current collector 120b may be formed from a first material (e.g., aluminum), which may have better compatibility with the second cathode 110b composition or the electrolyte included in the second cathode 110b. Similarly, the first anode current collector 150a may be formed from a first material (e.g., copper), which may have better compatibility with the first anode 140a composition or the electrolyte included in the first anode 140a.

To inhibit galvanic corrosion between the first anode current collector 150a and the second cathode current collector 120b, the second layer 120b2 of the second cathode current collector 120b that contacts the first anode current collector 150a may be formed from the second material, i.e., same material as the first anode current collector 150a (e.g., copper). Because the second layer 120b2 of the second cathode current collector 120b is formed from the same material as the anode current collector 150a, galvanic corrosion may be inhibited. Moreover, the seal member 160b may be disposed such that seal member 160b overlaps the second cathode current collector 120b so as to inhibit moisture ingress between the first layer 120b1 and the second layer 120b2, thus also inhibiting galvanic corrosion therebetween.

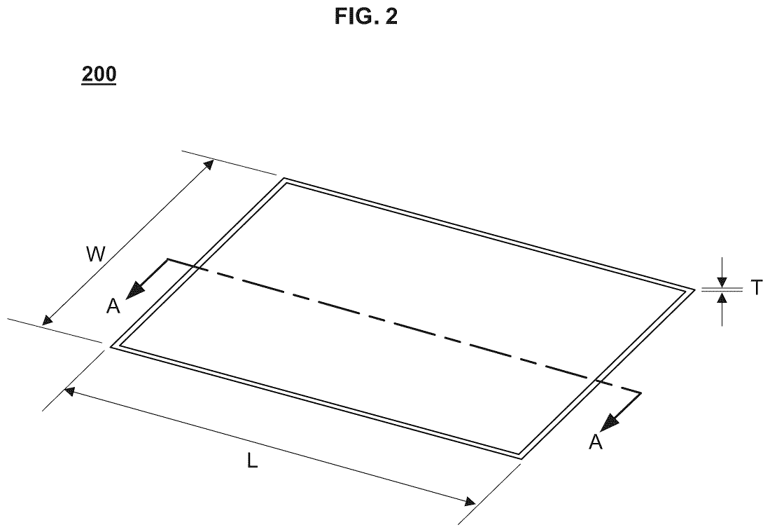

Referring now to FIGS. 2-4, FIG. 2 shows a top perspective view of an electrochemical cell 200, according to an embodiment. The electrochemical cell 200 can be same or substantially similar to the electrochemical cells 100a-b, as described above with reference to FIG. 1.

In some embodiments, a length L of the electrochemical cell 200 can be at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, at least about 1.1 m, at least about 1.2 m, at least about 1.5 m, at least about 2 m, at least about 2.5 m, at least about 3 m, or at least about 3.5 m. In some embodiments, the length L of the electrochemical cell 200 can be no more than about 5 m, no more than about 4.5 m, no more than about 4 m, no more than about 3.5 m, no more than about 3 m, no more than about 2.5 m, no more than about 2 m, no more than about 1.5 m, no more than about 1 m, no more than about 90 cm, no more than about 80 cm, no more than about 70 cm, no more than about 60 cm, no more than about 50 cm, no more than about 40 cm, no more than about 30 cm, or no more than about 20 cm. Combinations of the above-referenced lengths are also possible (e.g., at least about 5 cm and no more than about 5 m or at least about 1.0 m and no more than about 1.5 m), inclusive of all values and ranges therebetween. In some embodiments, the length L of the electrochemical cell 200 can about 10 cm, about 20 cm, about 30 cm, about 40 cm, about 50 cm, about 60 cm, about 70 cm, about 80 cm, about 90 cm, about 1 m, about 1.1 m, about 1.2 m, about 1.3 m, about 1.4 m, about 1.5 m, about 2 m, about 2.5 m, or about 3 m.

In some embodiments, a width W of the electrochemical cell 200 can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, or at least about 1.5 m. In some embodiments, the width W of the electrochemical cell 200 can be no more than about 2 m, no more than about 1.5 m, no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, or no more than about 5 cm. Combinations of the above-referenced widths are also possible (e.g., at least about 10 cm and no more than about 1 m or at least about 50 cm and no more than about 1.5 m), inclusive of all values and ranges therebetween. In some embodiments, the width W of the electrochemical cell 200 can be about 10 cm, about 20 cm, about 30 cm, about 40 cm, about 50 cm, about 60 cm, about 70 cm, about 80 cm, about 90 cm, about 1 m, about 1.5 m, or about 2 m.

In some embodiments, a thickness T of the electrochemical cell 200 can be at least about 50 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, or at least about 1 cm. In some embodiments, the thickness T of the electrochemical cell 200 can be no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, or no more than about 300 μm. Combinations of the above-referenced thicknesses are also possible (e.g., at least about 50 μm and no more than about 5 cm or at least about 1 mm and no more than about 5 cm), inclusive of all values and ranges therebetween. In some embodiments, the thickness T of the electrochemical cell 200 can be about 200 μm, about 300 μm, about 400 μm, about 500 μm, about 600 μm, about 700 μm, about 800 μm, about 900 μm, about 1 mm, about 2 mm, about 3 mm, about 4 mm, or about 5 mm.

In some embodiments, a ratio of the length L to the thickness T of the electrochemical cell 200 can be at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, at least about 900, or at least about 1,000. In some embodiments, the ratio of the width W to the thickness T of the electrochemical cell 200 can be at least about 1.5, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, or at least about 800.

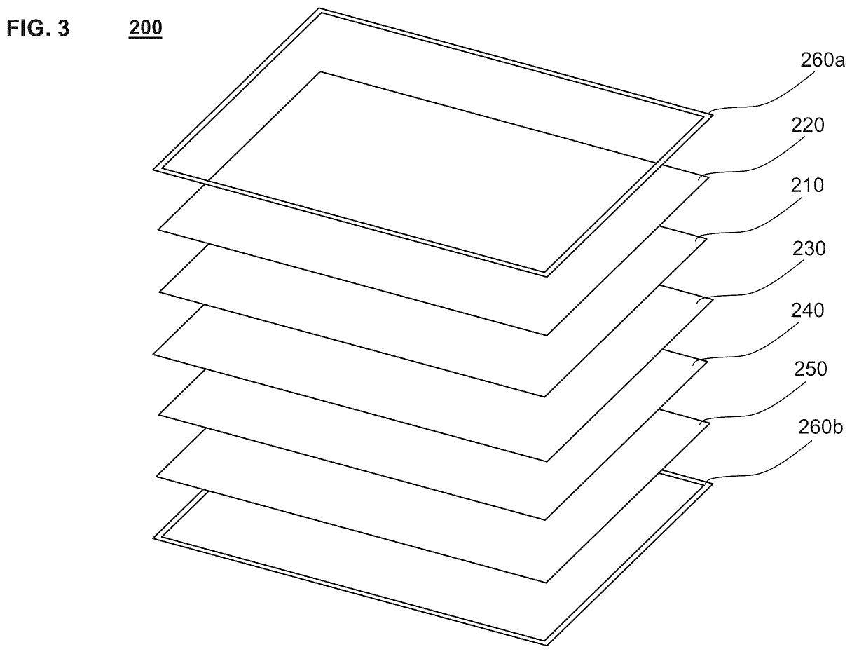

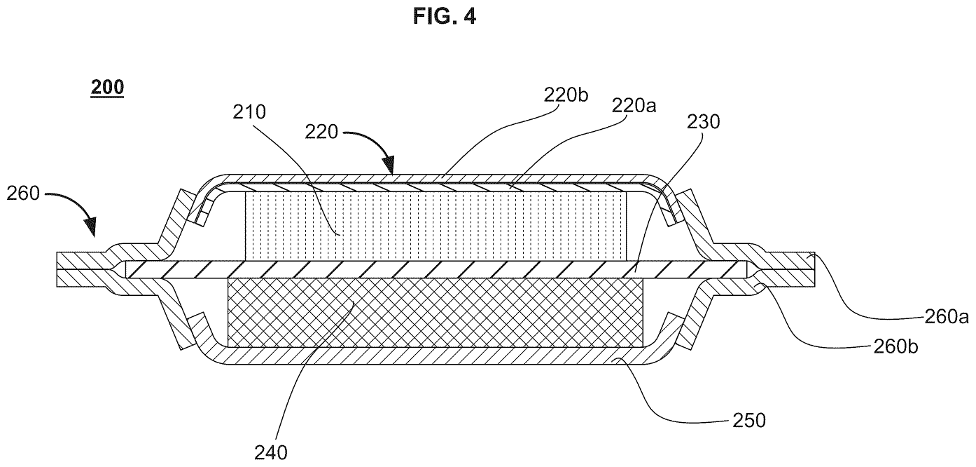

FIG. 3 is an exploded illustration of the electrochemical cell 200 of FIG. 2, and FIG. 4 is a side cross-sectional view of the electrochemical cell 200 taken along the cross-sectional line A-A shown in FIG. 2. The electrochemical cell 200 includes a cathode 210 disposed on a cathode current collector 220, an anode 240 disposed on an anode current collector 250, and a separator 230 disposed between the cathode 210 and the anode 240. The cathode current collector 220 includes a first layer 220a (shown in FIG. 4) and a second layer 220b disposed on the first layer 220a. The cathode 210 is disposed on the first layer 220a of the cathode current collector 220. In some embodiments, the first layer 220a may include a first material, and the second layer 220b may include a second material different from the first material. In some embodiments, the anode current collector 250 may include the second material. In some embodiments, the second layer 220b of the cathode current collector 220 and/or the anode current collector 250 may include copper. In some embodiments, the first layer 220a of the cathode current collector 220 may include aluminum.

The electrochemical cell 200 includes a seal member 260 having a first portion 260a and a second portion 260b, which are coupled to each other at their respective edges. For example, as shown in FIG. 4, the first portion 260a of the seal member 260 is physically in contact with the second layer 220b of the cathode current collector 220. The second portion 260b of the seal member 260 is physically in contact with the anode current collector 250. The first portion 260a and the second portion 260b of the seal member 260 are disposed around a peripheral edge of the electrochemical cell 200 and coupled to each other, thus hermetically sealing the cathode 210, the anode 240, and first layer 220a of the cathode current collector 220 in combination with the second layer 220b of the cathode current collector 220, and the anode current collector 250. As shown in FIGS. 3 and 4, in some embodiments, the first portion 260a and the second portion 260b of the seal members 260 can form a partial pouch but do not fully cover the second layer of the cathode current collector 220 or the anode current collector 250.

As shown in FIG. 4, in some embodiments, an outer edge of the first portion 260a of the seal member 260 can be folded towards the cathode 210 at an angle of about 45 degrees to about 90 degrees with respect to the lengthwise or widthwise dimension of the separator 230. In some embodiments, an outer edge of the second portion 260b of the seal member 260 can be folded towards the anode 240 at an angle of about 45 degrees to about 90 degrees with respect to respect to the lengthwise or widthwise dimension of the separator 230. In some embodiments, the seal member 260 may include a monolithic member over molded over the peripheral edges of the electrochemical cell 200, or disposed as a continuous layer around the peripheral edges of the electrochemical cell 200.

As shown in FIG. 4, in some embodiments, peripheral edges of both the cathode current collector 220 and the anode current collector 250 can be folded towards their respective electrodes (cathode 210 and anode 240, respectively), for example, to define a curvature. In some embodiments, the outer edges of each current collector 220, 250 can be folded at an angle ranging from about 30 to about 80 degrees relative to its corresponding electrode, for example, to define a curvature.

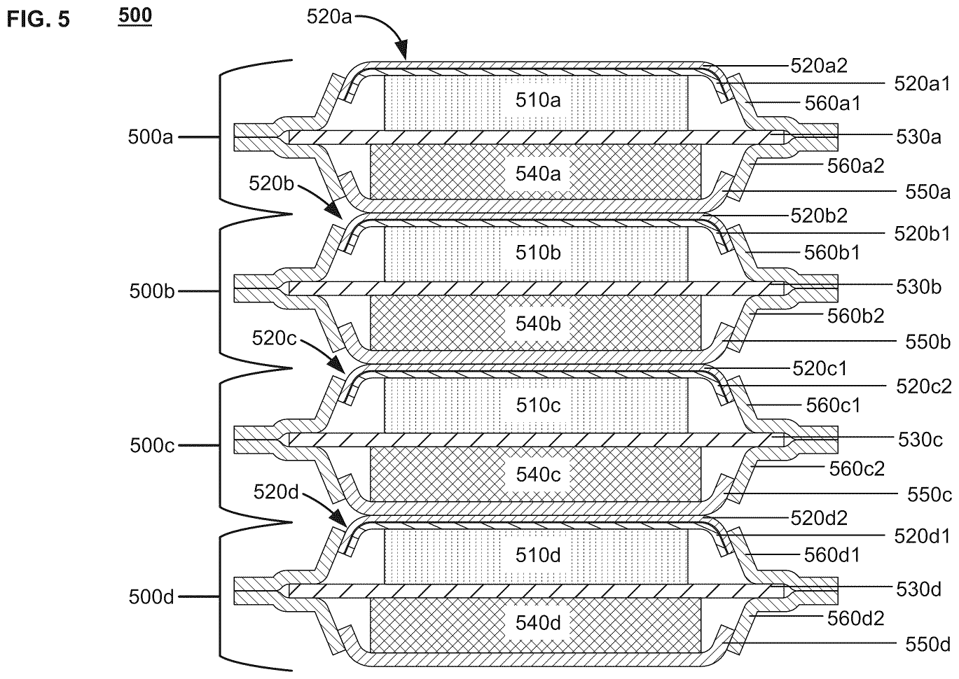

FIG. 5 is a cross-sectional view of an electrochemical cell stack 500, according to an embodiment. In some embodiments, the electrochemical cell stack 500 can include four electrochemical cells 500a, 500b, 500c, 500d (collectively referred to as “electrochemical cells 500a-d”). While shown as including the four electrochemical cells 500a-d in FIG. 5, in some embodiments, any number of electrochemical cells can be connected in series. In some embodiments, the electrochemical cell stack 500 can include 1, 2, 3, 4, 5, 6, 7, 8, 9, 10, 11, 12, 13, 14, 15, 16, 17, 18, 19, 20, or at least about 20 electrochemical cells. In some embodiments, the electrochemical cell stack 500 may include one or more electrochemical cells 500a-d connected in parallel. In some embodiments, the electrochemical cells 500a-d can be same or substantially similar to the electrochemical cells 100a-b and the electrochemical cell stack 100 or 200 as described above with reference to FIG. 1, and FIGS. 2-4, respectively.

The electrochemical cells 500a, 500b, 500c, 500d include cathodes 510a, 510b, 510c, 510d (collectively referred to as “cathodes 510”) disposed on cathode current collectors 520a, 520b, 520b, 520c, 520d, respectively. Each of the cathode current collectors 520a, 520b, 520b, 520c, 520d include first layers 520a1, 520b1, 520c1, 520d1 (collectively referred to as “first layers 520a1-d1”) disposed on, and in contact with respective cathodes 510a, 510b, 510c, 510c, and second layers 520a2, 520b2, 520c2, 520d2 (collectively referred to as “second layers 520a2-d2”) disposed on the first layers 520a1-d1. The electrochemical cells 500a-d further include anodes 540a, 540b, 540c, 540d (collectively referred to as “anodes 540”) disposed on anode current collectors 550a, 550b, 550c, 550d, respectively (collectively referred to as “anode current collectors 550”), and separators 530a, 530b, 530c, 530d (collectively referred to as separators 530) disposed between respective ones of the cathodes 510a, 510b, 510c, 510d and the anodes 540a, 540b, 540c, 540d.

In some embodiments, the first layers 520a1-d1 may include or be formed from a first material, and the second layers 520a2-d2 may include or be formed from a second material different from the first material. In some embodiments, the anode current collectors 550 may include the second material. In some embodiments, the second layers 520a2-d2 and/or the anode current collectors 550 may include copper. In some embodiments, the first layers 520a1-d1 may include aluminum.

As illustrated in FIG. 5, the second layers 520a2-d2 of the cathode current collectors 520a-d are in physical contact with the anode current collectors 550 of the adjacent electrochemical cells 500a-d. In some embodiments, both the second layers 520a2-d2 and the anode current collectors 550a-d of the adjacent electrochemical cells 500a-d may include materials with same or substantially similar physicochemical properties. This similarity can help reduce the galvanic potential compared to a cell stack where the cathode current collectors and anode current collectors, made from different materials, are in physical contact. In some embodiments, the thickness of the second layers 520a2-d2 and the anode current collectors 550 may be the same or different. In some embodiments, the anode current collectors 550 can be thicker than the second layers 520a2-d2 by a factor of at least about 1.1, at least about 1.2, at least about 1.3, at least about 1.4, at least about 1.5, at least about 1.6, at least about 1.7, at least about 1.8, at least about 1.9, at least about 2, at least about 2.1, at least about 2.2, at least about 2.3, at least about 2.5, at least about 3, at least about 3.5, at least about 4, at least about 4.5, or at least about 5.

In some embodiments, the anode current collectors 550 can be thicker than the first layers 520a1-d1 by a factor of at least about 1.1, at least about 1.2, at least about 1.3, at least about 1.4, at least about 1.5, at least about 1.6, at least about 1.7, at least about 1.8, at least about 1.9, at least about 2, at least about 2.1, at least about 2.2, at least about 2.3, at least about 2.5, at least about 3, at least about 3.5, at least about 4, at least about 4.5, or at least about 5.

In some embodiments, at least one of an insulation layer or a heating layer can be disposed between the adjacent electrochemical cells 500a-d. That is, in some embodiments, at least one of an insulation layer or a heating layer can be disposed between the second layers 520a2-d2 and the anode current collectors 550 of the adjacent electrochemical cells 500a-d.

In some embodiments, the electrochemical cells 500a-d can have the same battery chemistry. In some embodiments, the electrochemical cells 500a-d can have different battery chemistries.

In some embodiments, the voltage measured from the anode current collector 550d to the anode current collector 550b can be about double the voltage measured from the anode current collector 550d to the anode current collector 550c. As an example, the voltage measured from anode current collector 550d to anode current collector 550c can be about 3.2 V, the voltage measured from anode current collector 550d to anode current collector 550b can be about 6.4 V, the voltage measured from anode current collector 550d to anode current collector 550a can be about 9.6 V, and the voltage measured from anode current collector 550d to cathode current collector 520a1 can be about 12.8 V. Thus, stacking the electrochemical cells 500a-d in series can allow a user to make an electrical connection with any number of the electrochemical cells 500a-d of the electrochemical cell stack 500, thus allowing different voltages to be drawn from the stack 500 as desired.

In some embodiments, the electrochemical cell stack 500 may be disposed into a case with a cover placed thereon. In some embodiments, the case may include a voltage monitor (not shown) integrated therein. In some embodiments, the voltage monitor can monitor voltage drop across each of the electrochemical cells 500a-d. In some embodiments, a voltage selector may be provided, included, or disposed on the case to allow a user to select a desired voltage to be drawn from the stack 500.

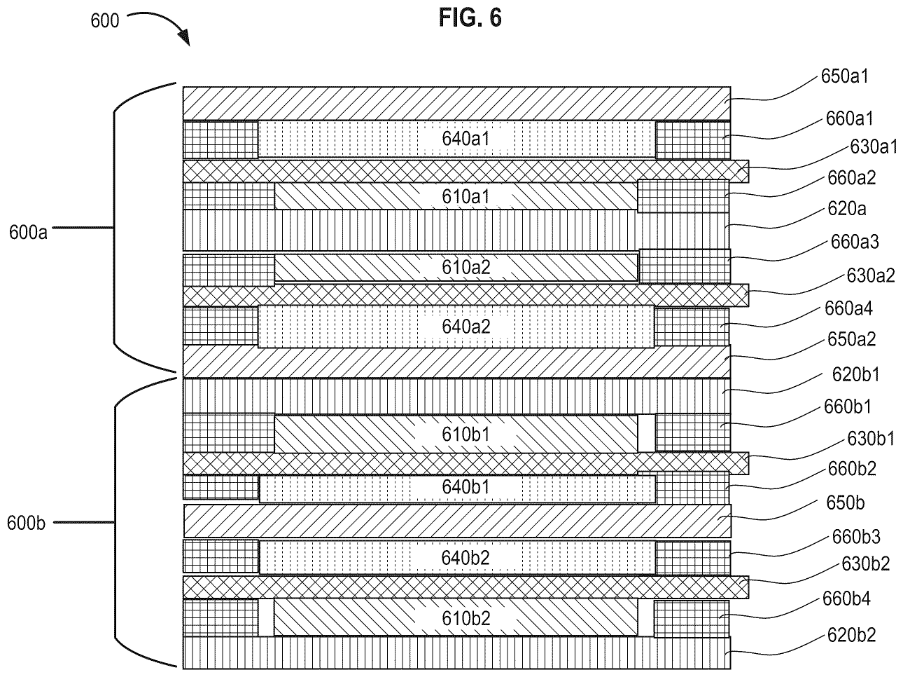

In some embodiments, an electrochemical cell stack can include bi-cells stacked on top of each other, i.e., electrochemical cells that each include more than one anode and/or cathode. Such electrochemical bi-cells can be stacked on top of each other in any suitable configuration to form an electrochemical cell stack, with the electrochemical bi-cells being electrically coupled to each other in series or in parallel. For example, FIG. 6 shows a block diagram of an electrochemical cell stack 600, according to an embodiment. The electrochemical cell stack 600 includes a first electrochemical cell 600a and a second electrochemical cell 600b electrically coupled to the first electrochemical cell 600a. In some embodiments, the first electrochemical cell 600a physically contacts the second electrochemical cell 600b. In some embodiments, the first electrochemical cell 600a is a bi-cell that includes a first electrode 640a1 (e.g., a first anode) disposed on a first current collector 650a1 (e.g., a first anode current collector), a second electrode 610a1 (e.g., a first cathode) disposed on a first side of a second current collector 620a (e.g., a cathode current collector). The first electrochemical cell 600a further includes a third electrode 610a2 (e.g., a second cathode) disposed on a second side of the second current collector 620a, opposite to the first side, and a fourth electrode 640a2 (e.g., a second anode) disposed on a third current collector 650a2 (e.g., a second anode current collector). The first electrochemical cell 600a may further include a first separator 630a1 disposed between the first electrode 640a1 and the second electrode 610a1, and a second separator 630a2 disposed between the third electrode 610a2 and the fourth electrode 640a2. The first electrochemical cell 600a further includes a plurality of seal members 660a1, 660a2, 660a3, 660a4, disposed around the first electrode 640a1, the second electrode 610a1, the third electrode 610a2, and the fourth electrode 640a2, respectively, for example, to hermetically seal edges of the respective electrodes.

In some embodiments, the second electrochemical cell 600b includes a first electrode 610b1 (e.g., a first cathode) disposed on a first current collector 620b1 (e.g., a first cathode current collector), a second electrode 640b1 (e.g., a first anode) disposed on a first side of a second current collector 650b (e.g., an anode current collector). In some embodiments, the second electrochemical cell 600b further includes a third electrode 640b2 (e.g., a second anode) disposed on a second side of the second current collector 650b (e.g., an anode current collector), opposite to the first side, and a fourth electrode 610b2 (e.g., a second cathode) disposed on a third current collector 620b2 (e.g., a second cathode current collector). The second electrochemical cell 600b further includes a first separator 630b1 disposed between the first electrode 610b1 and the second electrode 640b1, and a second separator 630b2 disposed between the third electrode 640b2 and the fourth electrode 610b2. The second electrochemical cell 600b further includes a plurality of seal members 660b1, 660b2, 660b3, 660b4, disposed around the first electrode 610b1, the second electrode 640b1, the third electrode 640b2, and the fourth electrode 610b2, respectively, for example, to hermetically seal edges of the respective electrodes.

In some embodiments, the fourth electrode 640a2 of the first electrochemical cell 600a can include an anode, and the first electrode 610b1 of the second electrochemical cell 600b can include a cathode.

In some embodiments, the third current collector 650a2 of the first electrochemical cell 600a can be disposed on the first current collector 620b1 of the second electrochemical cell 600b. In some embodiments, the third current collector 650a2 of the first electrochemical cell 600a and the first current collector 620b1 of the second electrochemical cell 600b may be in physical contact.

In some embodiments, the third current collector 650a2 of the first electrochemical cell 600a can include a first material, and the first current collector 620b1 of the second electrochemical cell 600b can include a second material different from the first material. In some embodiments, the first material can include copper and/or the second material can include aluminum.

In some embodiments, the second current collector 620a of the first electrochemical cell 600a can include aluminum. In some embodiments, the second current collector 650b of the second electrochemical cell 600b can include copper.

In some embodiments, the first electrode 640a1 and the fourth electrode 640a2 of the first electrochemical cell 600a can include an anode, and the second electrode 610a1 and the third electrode 610a2 of the first electrochemical cell 600a can include a cathode. In some embodiments, the first electrode 610b1 and the fourth electrode 610b2 of the second electrochemical cell 600b can include a cathode and the second electrode 640b1 and the third electrode 640b2 of the second electrochemical cell 600b can include an anode. In some embodiments, the anodes and the cathodes can be same or substantially similar to the anodes and the cathodes described above with respect to FIG. 1.

In some embodiments, the first electrode 640a1 and the fourth electrode 640a2 of the first electrochemical cell 600a, and the second electrode 640b1 and the third electrode 640b2 of the second electrochemical cell 600b can have the same or substantially similar chemical composition. In some embodiments, the first electrode 640a1 and the fourth electrode 640a2 of the first electrochemical cell 600a, and the second electrode 640b1 and the third electrode 640b2 of the second electrochemical cell 600b can have different chemical composition, thickness, density, porosity, and/or any other properties.

In some embodiments, the second electrode 610a1 and the third electrode 610a2 of the first electrochemical cell 600a, and the first electrode 610b1 and the fourth electrode 610b2 of the second electrochemical cell 600b can have the same or substantially similar chemical composition. In some embodiments, the second electrode 610a1 and the third electrode 610a2 of the first electrochemical cell 600a, and the first electrode 610b1 and the fourth electrode 610b2 of the second electrochemical cell 600b can have different chemical composition, thickness, density, porosity, and/or any other properties.

In some embodiments, the second current collector 620a of the first electrochemical cell 600a can be thicker than at least one of the first current collector 650a1 and/or the third current collector 650a2 of the first electrochemical cell 600a by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, at least one of the first current collector 650a1 and/or the third current collector 650a2 of the first electrochemical cell 600a can be thicker than the second current collector 620a of the first electrochemical cell 600a by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the second current collector 650b of the second electrochemical cell 600b can be thicker than at least one of the first current collector 620b1 or the third current collector 620b2 of the second electrochemical cell 600b by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, at least one of the first current collector 620b1 or the third current collector 620b2 of the second electrochemical cell 600b can be thicker than the second current collector 650b of the second electrochemical cell 600b by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the third current collector 650a2 of the first electrochemical cell 600a can be electrically coupled to the first current collector 620b1 of the second electrochemical cell 600b in series. Electrical contact between adjacent current collectors can be realized by various methods, such as, for example, mechanical compression, use of an electrically conductive paste, welding, brazing, soldering, or other suitable technique. In such an electrochemical cell stack (i.e., a bipolar stack), the stack voltage can reflect the serial connection of all the cells composing it, and is thus substantially equal to the sum of the individual voltages.

In some embodiments, at least two of the electrodes 640a1, 610a1, 610a2, 640a2, 610b1, 640b1, 640b2, 610b2 within the electrochemical cell stack 600 may have a different thickness from one another. In some embodiments, at least two of the electrodes 640a1, 610a1, 610a2, 640a2, 610b1, 640b1, 640b2, 610b2 within the electrochemical cell stack 600 may have same or substantially similar thickness.

In some embodiments, the first electrode 640a1 and the fourth electrode 640a2 of the first electrochemical cell 600a may have same or substantially similar thickness. In some embodiments, the second electrode 610a1 and the third electrode 610a2 of the first electrochemical cell 600a may have same or substantially similar thickness. In some embodiments, the thickness of at least one of the first electrode 640a1 or the fourth electrode 640a2 of the first electrochemical cell 600a may be different from the thickness of at least one of the second electrode 610a1 or the third electrode 610a2 of the first electrochemical cell 600a.

In some embodiments, the first electrode 610b1 and the fourth electrode 610b2 of the second electrochemical cell 600b may have same or substantially similar thickness. In some embodiments, the second electrode 640b1 and the third electrode 640b2 of the second electrochemical cell 600b may have same or substantially similar thickness. In some embodiments, the thickness of at least one of the first electrode 610b1 or the fourth electrode 610b2 of the second electrochemical cell 600b may be different from the thickness of at least one of the second electrode 640b1 or the third electrode 640b2 of the second electrochemical cell 600b.

In some embodiments, the thickness of the first electrode 640a1 and the fourth electrode 640a2 of the first electrochemical cell 600b may be same or substantially similar to the thickness of at least one of the second electrode 640b1 and the third electrode 640b2 of the second electrochemical cell 600b. In some embodiments, the thickness of the first electrode 640a1 and the fourth electrode 640a2 of the first electrochemical cell 600a may be different from that of at least one of the second electrode 640b1 and the third electrode 640b2 of the second electrochemical cell 600b.

In some embodiments, the first electrochemical cell 600a and/or the second electrochemical cell 600b can include conventional electrodes (e.g., solid electrodes with binders). In some embodiments, the thickness of the conventional electrodes can be in the range of about 20 μm to about 100 μm, about 20 μm to about 90 μm, about 20 μm to about 80 μm, about 20 μm to about 70 μm, about 20 μm to about 60 μm, about 25 μm to about 60 μm, about 30 μm to about 60 μm, about 20 μm to about 55 μm, about 25 μm to about 55 μm, about 30 μm to about 55 μm, about 20 μm to about 50 μm, about 25 μm to about 50 μm, or about 30 μm to about 50 μm, inclusive of all values and ranges therebetween. In some embodiments, the thickness of the conventional electrodes can be about 20 μm, about 25 μm, about 30 μm, about 35 μm, about 40 μm, about 45 μm, about 50 μm, about 55 μm, or about 60 μm, inclusive of all values and ranges therebetween.

In some embodiments, the electrodes 640a1, 610a1, 610a2, 640a2, 610b1, 640b1, 640b2, and 610b2 of the electrochemical cell stack 600 can have a thickness independently selected from a thickness of at least about 20 μm, at least about 30 μm, at least about 40 μm, at least about 50 μm, at least about 60 μm, at least about 70 μm, at least about 80 μm, at least about 90 μm, at least about 100 μm, at least about 110 μm, at least about 120 μm, at least about 130 μm, or at least about 140 μm. In some embodiments, the electrodes 640a1, 610a1, 610a2, 640a2, 640b1, 610b1, 630b2, 610b2, 640b2 of the electrochemical cell stack 600 can have a thickness independently selected from a thickness of no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, no more than about 60 μm, no more than about 50 μm, or no more than about 30 μm. Combinations of the above-referenced thicknesses are also possible (e.g., at least about 20 μm and no more than about 150 μm or at least about 50 μm and no more than about 100 μm), inclusive of all values and ranges therebetween. In some embodiments, the electrodes 640a1, 610a1, 610a2, 640a2, 640b1, 610b1, 630b2, 610b2, 640b2 can have a thickness independently selected from a thickness of about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, or about 150 μm.

In some embodiments, the first electrochemical cell 600a and/or the second electrochemical cell 600b can have a thickness of at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, or at least about 950 μm. In some embodiments, the first electrochemical cell 600a and/or the second electrochemical cell 600b can have a thickness of no more than about 1,000 μm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, or no more than about 150 μm. Combinations of the above-referenced thicknesses are also possible (e.g., at least about 100 μm and no more than about 1,000 μm or at least about 200 μm and no more than about 500 μm), inclusive of all values and ranges therebetween. In some embodiments, the first electrochemical cell 600a and/or the second electrochemical cell 600b can have a thickness of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, or about 1,000 μm.

In some embodiments, the second electrochemical cell 600b can have a thickness the same or substantially similar to a thickness of the first electrochemical cell 600a. In some embodiments, the second electrochemical cell 600b can have a thickness greater than the thickness of the first electrochemical cell 600a. In some embodiments, the second electrochemical cell 600b can be thicker than the first electrochemical cell 600a by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, a plurality of seal members 660a1, 660a2, 660a3, 660a4, 660b1, 660b2, 660b3, 660b4 (collectively referred to as seal members 660) are disposed around peripheral edges of the electrochemical cell stack 600.

In some embodiments, the seal members 660 can have a width W parallel to the lengthwise or widthwise dimension of the separators 630a1, 630a2, 630b1, 630b2 (collectively referred to as separators 630). In some embodiments, the seal members 660a2, 660a3, 660b1, 660b4 that are disposed around peripheral edges of the electrodes 610a1, 610a2, 610b1, 610b2 (e.g., cathodes) of the electrochemical cell stack 600 may be wider than the seal members 660a1, 660a4, 660b2, 660b3 that are disposed around peripheral edges of the electrodes 640a1, 640a2, 640b1, 640b2 (e.g., anodes) of the electrochemical cell stack 600.

In some embodiments, the seal members 660a2, 660a3, 660b1, 660b4 that are disposed around peripheral edges of the electrodes 610a1, 610a2, 610b1, 610b2 (e.g., cathodes) of the electrochemical cell stack 600 may be wider than the seal members 660a1, 660a4, 660b2, 660b3 that are disposed around peripheral edges of the electrodes 640a1, 640a2, 640b1, 640b2 (e.g., anodes) of the electrochemical cell stack 600 by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the seal members 660a1, 660a4, 660b2, 660b3 that are disposed around peripheral edges of the electrodes 640a1, 640a2, 640b1, 640b2 (e.g., anodes) of the electrochemical cell stack 600 may be wider than the seal members 660a2, 660a3, 660b1, 660b4 that are disposed around peripheral edges of the electrodes 610a1, 610a2, 610b1, 610b2 (e.g., cathodes) of the electrochemical cell stack 600 by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the seal members 660 have a thickness T perpendicular to the lengthwise or widthwise dimension of the separators 630. In some embodiments, the seal members 640 may have the same or substantially similar thickness. In some embodiments, at least two of the seal members 640 may have different thickness from one another.

In some embodiments, the seal members 660a2, 660a3, 660b1, 660b4 that are disposed around peripheral edges of the electrodes 610a1, 610a2, 610b1, 610b2 (e.g., cathodes) of the electrochemical cell stack 600 may be thicker than the seal members 660a1, 660a4, 660b2, 660b3 that are disposed around peripheral edges of the electrodes 640a1, 640a2, 640b1, 640b2 (e.g., anodes) of the electrochemical cell stack 600 by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the seal members 660a1, 660a4, 660b2, 660b3 that are disposed around peripheral edges of the electrodes 640a1, 640a2, 640b1, 640b2 (e.g., anodes) of the electrochemical cell stack 600 may be thicker than the seal members 660a2, 660a3, 660b1, 660b4 that are disposed around peripheral edges of the electrodes 610a1, 610a2, 610b1, 610b2 (e.g., cathodes) of the electrochemical cell stack 600 by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, each electrode (640a1, 610a1, 610a2, 640a2, 610b1, 640b1, 640b2, 610b2) within the electrochemical cell stack 600 may be exposed to a substantially uniform pressure upon the application of stack pressure. In other embodiments, the fabrication of seal members 660 of varying sizes can facilitate the equal distribution of stack pressure across each electrode.

In some embodiments, the first electrochemical cell 600a and the second electrochemical cell 600b can be disposed in a single pouch.

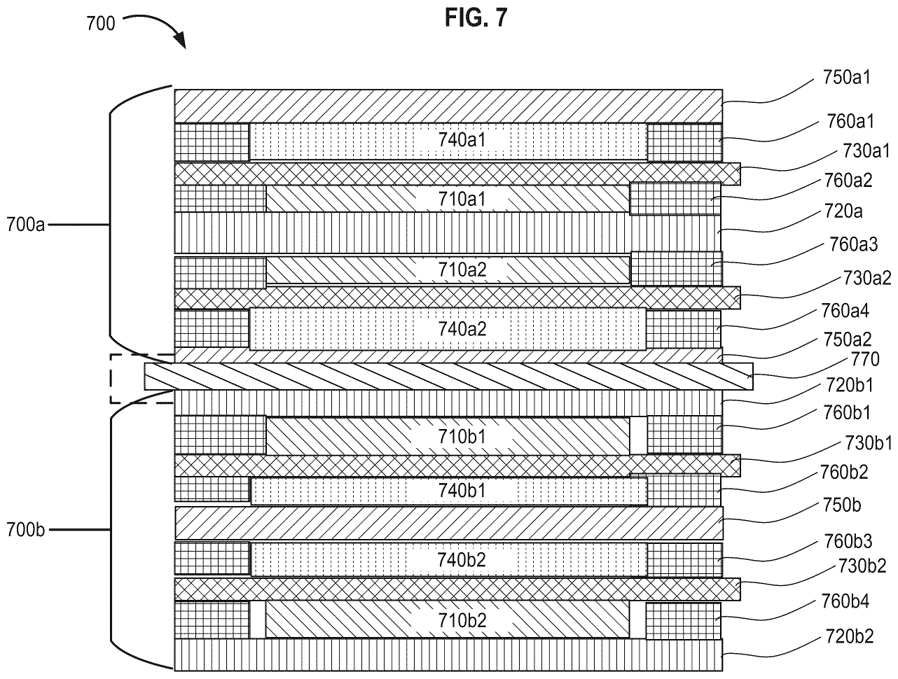

FIG. 7 is a block diagram of an electrochemical cell stack 700, according to an embodiment. The electrochemical cell stack 700 includes a first electrochemical cell 700a and a second electrochemical cell 700b electrically coupled to the first electrochemical cell 700a in series. In some embodiments, the first electrochemical cell 700a includes a first electrode 740a1 (e.g., a first anode) disposed on a first current collector 750a1 (e.g., a first anode current collector), a second electrode 710a1 (e.g., a first cathode) disposed on a first side of a second current collector 720a (e.g., a cathode current collector). The first electrochemical cell 700a further includes a third electrode 710a2 (e.g., a second cathode) disposed on a second side of the second current collector 720a, opposite to the first side, and a fourth electrode 740a2 (e.g., a second anode) disposed on a third current collector 750a2 (e.g., a second anode current collector).

The first electrochemical cell 700a further includes a first separator 730a1 disposed between the first electrode 740a1 and the second electrode 710a1, and a second separator 730a2 disposed between the third electrode 710a2 and the fourth electrode 740a2. The first electrochemical cell 700a further includes a plurality of seal members 760a1, 760a2, 760a3, 760a4, disposed around the first electrode 740a1, the second electrode 710a1, the third electrode 710a2, and the fourth electrode 740a2, respectively.

In some embodiments, the second electrochemical cell 700b includes a first electrode 710b1 (e.g., a first cathode) disposed on a first current collector 720b1 (e.g., a first cathode current collector), a second electrode 740b1 (e.g., a first anode) disposed on a first side of a second current collector 750b (e.g., an anode current collector). In some embodiments, the second electrochemical cell 700b further includes a third electrode 740b2 (e.g., a second anode) disposed on a second side of the second current collector 750b, opposite to the first side, and a fourth electrode 710b2 (e.g., a second cathode) disposed on a third current collector 720b2 (e.g., a second cathode current collector). The second electrochemical cell 700b further includes a first separator 730b1 disposed between the first electrode 710b1 and the second electrode 740b1, and a second separator 730b2 disposed between the third electrode 740b2 and the fourth electrode 710b2. The second electrochemical cell 700b further includes a plurality of seal members 760b1, 760b2, 760b3, 760b4, disposed around the first electrode 710b1, the second electrode 740b1, the third electrode 740b2, and the fourth electrode 710b2, respectively.

In some embodiments, a plurality of seal members 760a1, 760a2, 760a3, 760a4, 760b1, 760b2, 760b3, 760b4 (collectively referred to as seal members 760) are disposed around peripheral edges of the electrochemical cell stack 700.

In some embodiments, the electrochemical cells 700a, and 700b can be same or substantially similar to the electrochemical cells 600a, and 600b, respectively, described above with respect to FIG. 6. Different from the electrochemical cell stack 600, the electrochemical cell stack 700 can include an interlayer 770 disposed between the first electrochemical cell 700a and the second electrochemical cell 700b. For example, the interlayer 770 may be disposed between the third current collector 750a2 of the first electrochemical cell 700a and the first current collector 720b1 of the second electrochemical cell 700b.

In some embodiments, the interlayer 770 can be selected from at least one of an insulation layer or a heating layer. In some embodiments, the peripheral edges of the interlayer 770 can extend beyond the third current collector 750a2 of the first electrochemical cell 700a and/or the first current collector 720b1 of the second electrochemical cell 700b. In some embodiments, the interlayer 770 may include a tab for electrical connectivity. In some embodiments, the interlayer 770 may be coupled to other functional parts of a battery system that ensures the safety and/or efficiency of the electrochemical cell stack 700.

In some embodiments, the interlayer 770 can include a heating layer. In some embodiments, the heating layer may include strips. In some embodiments, the heating layer may be in the form of a foil. The heating layer may include a solid state or a resistive heater. The heating layer can aid in maintaining an elevated operating temperature. The heating layer can be beneficial for cell designs intended to operate at higher temperatures (e.g., at least about 25° C., at least about 30° C., at least about 35° C., at least about 40° C., at least about 45° C., or at least about 50° C.).

In some embodiments, the heating layer may be configured to perform a heat exchange function, i.e., they can also function as heat collectors and dissipaters. In some embodiments, the heating layer may be configured to keep the cell operating temperature within a specified range. In some embodiments, the heating layer may be configured to dissipate the heat which is generated during the operation of the electrochemical cell stack 700.

In some embodiments, the interlayer 770 can include an insulating layer. In some embodiments, the insulation layer may be configured to delay or prevent heat transfer between the first electrochemical cell 700a and the second electrochemical cell 700b. In some embodiments, the insulation layer may include at least one of cotton, carbon fiber cotton, ceramic fiber cotton, aerogels, glass fiber, ceramic boards, rock wool boards, silica aerogel, or graphite composite plates. The choice of material that forms the insulation layer depends on its thermal and electrical insulation properties, flame retardance, and suitability for the specific design and space constraints. In some embodiments, the insulator layer can limit heat transfer within the electrochemical cell stack 700.

In some embodiments, the first electrochemical cell 700a and the second electrochemical cell 700b can be electrically coupled by using any known methods in the art. For example, the first electrochemical cell 700a and the second electrochemical cell 700b can be electrically coupled through tabs extending from suitable current collectors, for example, a first tab extending from the current collector 750a2 coupled to a second tab extending from current collector 720b1 to couple the first electrochemical cell 700a to the second electrochemical cell 700b in series.

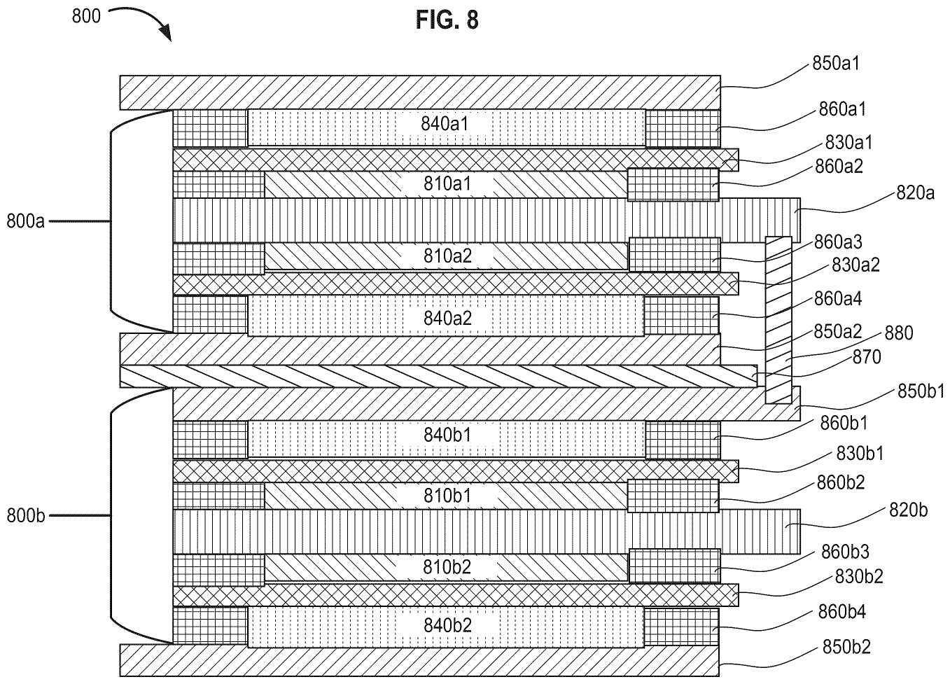

FIG. 8 is a block diagram of an electrochemical cell stack 800, according to an embodiment. The electrochemical cell stack 800 includes a first electrochemical cell 800a and a second electrochemical cell 800b electrically coupled to the first electrochemical cell 800a in series. In some embodiments, the first electrochemical cell 800a includes a first electrode 840a1 (e.g., a first anode) disposed on a first current collector 850a1 (e.g., a first anode current collector), a second electrode 810a1 (e.g., a first cathode) disposed on a first side of a second current collector 820a (e.g., a cathode current collector). The first electrochemical cell 800a further includes a third electrode 810a2 (e.g., a second cathode) disposed on a second side of the second current collector 820a, opposite to the first side, and a fourth electrode 840a2 (e.g., a second anode) disposed on a third current collector 850a2 (e.g., a second anode current collector). The first electrochemical cell 800a further includes a first separator 830a1 disposed between the first electrode 840a1 and the second electrode 810a1, and a second separator 830a2 disposed between the third electrode 810a2 and the fourth electrode 840a2. The first electrochemical cell 800a further includes a plurality of seal members 860a1, 860a2, 860a3, 860a4, disposed around the first electrode 840a1, the second electrode 810a1, the third electrode 810a2, and the fourth electrode 840a2, respectively.

In some embodiments, the second electrochemical cell 800b includes a first electrode 840b1 (e.g., a first anode) disposed on a first current collector 850b1 (e.g., a first anode current collector), a second electrode 810b1 (a first cathode) disposed on a first side of a second current collector 820b (e.g., a first cathode current collector. In some embodiments, the second electrochemical cell 800b further includes a third electrode 810b2 (e.g., a second cathode) disposed on a second side of the second current collector 820b, opposite to the first side, and a fourth electrode 840b2 (e.g., a second anode) disposed on a third current collector 850b2 (e.g., a second anode current collector). The second electrochemical cell 800b further includes a first separator 830b1 disposed between the first electrode 840b1 and the second electrode 810b1, and a second separator 830b2 disposed between the third electrode 810b2 and the fourth electrode 840b2. The second electrochemical cell 800b further includes a plurality of seal members 860b1, 860b2, 860b3, 860b4, disposed around the first electrode 840b1, the second electrode 810b1, the third electrode 810b2, and the fourth electrode 840b2, respectively.

In some embodiments, a plurality of seal members 860a1, 860a2, 860a3, 860a4, 860b1, 860b2, 860b3, 860b4 (collectively referred to as seal members 860) are disposed around peripheral edges of the electrochemical cell stack 800.

In some embodiments, the electrochemical cell stack 800 can include an interlayer 870 disposed between the third current collector 850a2 of the first electrochemical cell 800a and the first current collector 850b1 of the second electrochemical cell 800b. In some embodiments, the interlayer 870 may be selected from at least one of an insulation layer or a heating layer. In some embodiments, the peripheral edges of the interlayer 870 can extend beyond the seal members 860. In some embodiments, the interlayer 870 may be coupled to other functional parts of a battery system that ensures the safety and/or efficiency of the electrochemical cell stack 800. In some embodiments, the interlayer 870 may include a tab for electrical connectivity. In some embodiments, the interlayer 870 may be same or substantially similar to the interlayer 770 described with respect to FIG. 7.

In some embodiments, each of the current collectors 820a, 820b, 850a1, 850a2, 850b1, 850b2 may include tabs laterally out of the electrochemical cells beyond a lateral extent of the corresponding seal members 860a1, 860a2, 860a3, 860a4, 860b1, 860b2, 860b3, 860b4 and may be configured to be electrically coupled to external connectors or terminals. In some embodiments, in which the electrochemical cells 800a and 800b are coupled in series, a tab of the current collector 820a (e.g., a cathode current collector) of the first electrochemical cells 800a may be electrically coupled to a tab of the first current collector 850b1 (e.g., a first anode current collector) of the second electrochemical cell 800b via electrical coupling 880. Any suitable electrical coupling can be used, for example, a metal plate, a bond, a weld, etc., such that the respective tabs are electrically coupled to each other.

In some embodiments, an outer edge of at least one of the current collectors 850a1, 820a, 850a2 of the first electrochemical cell 800a can extend out of the first electrochemical cell 800a.

In some embodiments, an outer edge of at least one of the current collectors 850b1, 820b, 850b2 of the second electrochemical cell 800b can extend out of the second electrochemical cell 800b.

In some embodiments, the fourth electrode 840a2 of the first electrochemical cell 800a and the first electrode 840b1 of the second electrochemical cell 800b can include an anode. In some embodiments, the third current collector 850a2 of the first electrochemical cell 800a can be disposed on the first current collector 850b1 of the second electrochemical cell 800b. In some embodiments, the interlayer 870 can be disposed between the third current collector 850a2 of the first electrochemical cell 800a and the first current collector 850b1 of the second electrochemical cell 800b. In some embodiments, the third current collector 850a2 of the first electrochemical cell 800a and the first current collector 850b1 of the second electrochemical cell 800b can include the same material. For example, in some embodiments, the third current collector 850a2 of the first electrochemical cell 800a and the first current collector 850b1 of the second electrochemical cell 800b can include copper. In some embodiments, the second 810a1 and the third 810a2 electrodes of the first electrochemical cell 800a include a cathode and the second current collector 820a of the first electrochemical cell 800a includes a cathode current collector, and the second current collector 820a of the first electrochemical cell 800a can be coupled to the first current collector 850b1 of the second electrochemical cell 800b to electrically couple the first electrochemical cell 800a to the second electrochemical cell 800b in series. In some embodiments, the anodes and the cathodes can be same or substantially similar to the anodes and the cathodes described above with respect to FIG. 1.

In some embodiments, the second current collector 820a of the first electrochemical cell 800a can include aluminum. In some embodiments, the first current collector 850b1 of the second electrochemical cell 800b can include copper.

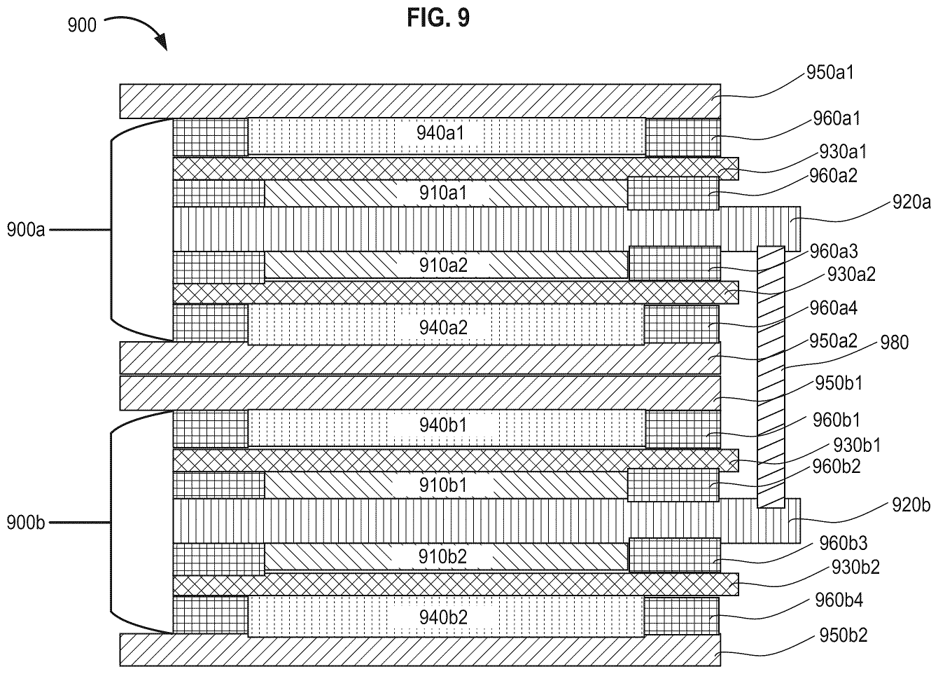

FIG. 9 is a block diagram of an electrochemical cell stack 900, according to an embodiment. The electrochemical cell stack 900 includes a first electrochemical cell 900a and a second electrochemical cell 900b electrically coupled to the first electrochemical cell 900a in parallel. In some embodiments, the first electrochemical cell 900a physically contacts the second electrochemical cell 900b. In some embodiments, a pouch material (e.g., an insulating material) can be disposed between the first electrochemical cell 900a and the second electrochemical cell 900b.

In some embodiments, the first electrochemical cell 900a includes a first electrode 940a1 (e.g., a first anode) disposed on a first current collector 950a1 (e.g., a first anode current collector), a second electrode 910a1 (e.g., a first cathode) disposed on a first side of a second current collector 920a (e.g., a cathode current collector). The first electrochemical cell 900a further includes a third electrode 910a2 (e.g., a second cathode) disposed on a second side of the second current collector 920a, opposite to the first side, and a fourth electrode 940a2 (e.g., a second anode) disposed on a third current collector 950a2 (e.g., a second anode current collector). The first electrochemical cell 900a further includes a first separator 930a1 disposed between the first electrode 940a1 and the second electrode 910a1, and a second separator 930a2 disposed between the third electrode 910a2 and the fourth electrode 940a2. The first electrochemical cell 900a further includes a plurality of seal members 960a1, 960a2, 960a3, 960a4, disposed around the first electrode 940a1, the second electrode 910a1, the third electrode 910a2, and the fourth electrode 940a2, respectively.

In some embodiments, the second electrochemical cell 900b includes a first electrode 940b1 (e.g., a first anode) disposed on a first current collector 950b1 (e.g., a first anode current collector), a second electrode 910b1 (e.g., a first cathode) disposed on a first side of a second current collector 920b (e.g., a cathode current collector). In some embodiments, the second electrochemical cell 900b further includes a third electrode 910b2 (e.g., a second cathode) disposed on a second side of the second current collector 920b, opposite to the first side, and a fourth electrode 940b2 (e.g., a second anode) disposed on a third current collector 950b2 (e.g., a second anode current collector). The second electrochemical cell 900b further includes a first separator 930b1 disposed between the first electrode 940b1 and the second electrode 910b1, and a second separator 930b2 disposed between the third electrode 910b2 and the fourth electrode 940b2. The second electrochemical cell 900b further includes a plurality of seal members 960b1, 960b2, 960b3, 960b4, disposed around the first electrode 940b1, the second electrode 910b1, the third electrode 910b2, and the fourth electrode 940b2, respectively.

In some embodiments, a plurality of seal members 960a1, 960a2, 960a3, 960a4, 960b1, 960b2, 960b3, 960b4 (collectively referred to as seal members 960) are disposed around peripheral edges of the electrochemical cell stack 900.

In some embodiments, the electrochemical cells 900a and 900b can be same or substantially similar to the electrochemical cells 800a and 800b, respectively, described above with respect to FIG. 8.

In some embodiments, the first electrochemical cell 900a is electrically coupled to the second electrochemical cell 900b in parallel. For example, the second current collector 920a (e.g., a cathode current collector) of the first electrochemical cell 900a includes a first tab, and the second current collector 920b (e.g., a cathode current collector) of the second electrochemical cell 900b includes a second tab. In some embodiments, the first tab and the second tab can be cathode current collector tabs. In some embodiments, as seen in FIG. 9, the first tab and the second (e.g., cathode tabs) can extend out of the electrochemical cell stack 900 in a parallel direction with respect to each other. This arrangement can enable the first tab and the second tab to be electrically coupled or connect with each other such that the first electrochemical cell 900a and the second electrochemical cell 900b can be electrically coupled in parallel. In some embodiments, the first tab and the second tab can be coupled to an electrical coupling 980 (e.g., a metal plate, a bond, a weld, or a load) such that the first tab and the second tab is electrically coupled to each other.

In some embodiments, an outer edge of at least one of the current collectors 950a1, 920a, 950a2 of the first electrochemical cell 900a can extend out the first electrochemical cell 900a.

In some embodiments, an outer edge of at least one of the current collectors 950b1, 920b, 950b2 of the second electrochemical cell 900b can extend out of the second electrochemical cell 900b.

In some embodiments, the electrochemical cell stack 900 can further include a tab that extends out of the current collectors 950a1, 950a2, 950b1, or 950b2 such that the tab extends in an opposite direction compared to the first and the second tabs.

In some embodiments, the fourth electrode 940a2 of the first electrochemical cell 900a and the first electrode 940b1 of the second electrochemical cell 900b can include an anode. In some embodiments, the third current collector 950a2 of the first electrochemical cell 900a can be disposed on the first current collector 950b1 of the second electrochemical cell 900b, for example, with an interlayer therebetween. In some embodiments, the third current collector 950a2 of the first electrochemical cell 900a and the first current collector 950b1 of the second electrochemical cell 900b can include the same material. For example, in some embodiments, the third current collector 950a2 of the first electrochemical cell 900a and the first current collector 950b1 of the second electrochemical cell 900b can include copper.

In some embodiments, the second electrodes 910a1, 910b1 and the third electrodes 910a2, 910b2 of the first and second electrochemical cells 900a, 900b can include a cathode. In some embodiments, the second current collector 920a, 920b of each of the first and second electrochemical cells 900a, 900b can include a cathode current collector, and the second current collector 920a of the first electrochemical cell 900a can be coupled to the second current collector 920b of the second electrochemical cell 900b to electronically couple the first electrochemical cell 900a to the second electrochemical cell 900b in parallel. In some embodiments, the anodes and the cathodes can be same or substantially similar to the anodes and the cathodes described above with respect to FIG. 1.

In some embodiments, the second current collector 920a of the first electrochemical cell 900a can include aluminum. In some embodiments, the second current collector 920b of the second electrochemical cell 900b can include aluminum.

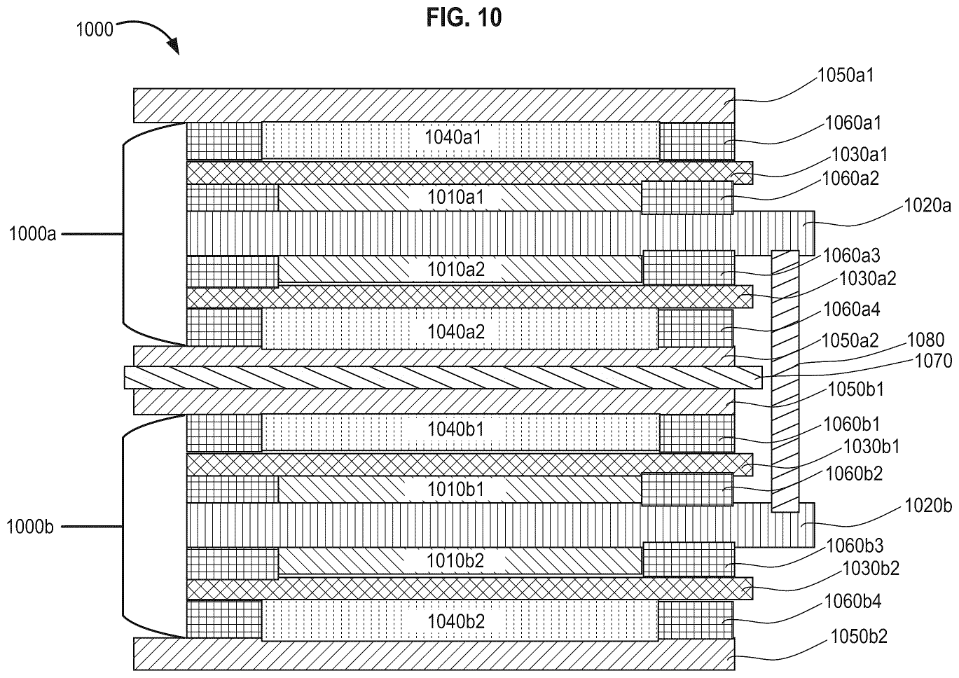

FIG. 10 is a block diagram of an electrochemical cell stack 1000, according to an embodiment. The electrochemical cell stack 1000 includes a first electrochemical cell 1000a and a second electrochemical cell 1000b electrically coupled to the first electrochemical cell 1000a in parallel. In some embodiments, the first electrochemical cell 1000a is physically in contact with the second electrochemical cell 1000b. In some embodiments, a pouch material (e.g., an insulating material) can be disposed between the first electrochemical cell 1000a and the second electrochemical cell 1000b.

In some embodiments, the first electrochemical cell 1000a includes a first electrode 1040a1 (e.g., a first anode) disposed on a first current collector 1050a1 (e.g., a first anode current collector), a second electrode 1010a1 (e.g., a first cathode) disposed on a first side of a second current collector 1020a (e.g., a cathode current collector). The first electrochemical cell 1000a further includes a third electrode 1010a2 (e.g., a second cathode) disposed on a second side of the second current collector 1020a, opposite to the first side, and a fourth electrode 1040a2 (e.g., a second anode) disposed on a third current collector 1050a2 (e.g., a second anode current collector). The first electrochemical cell 1000a further includes a first separator 1030a1 disposed between the first electrode 1040a1 and the second electrode 1010a1, and a second separator 1030a2 disposed between the third electrode 1010a2 and the fourth electrode 1040a2. The first electrochemical cell 1000a further includes a plurality of seal members 1060a1, 1060a2, 1060a3, 1060a4, disposed around the first electrode 1040a1, the second electrode 1010a1, the third electrode 1010a2, and the fourth electrode 1040a2, respectively.

In some embodiments, the second electrochemical cell 1000b includes a first electrode 1040b1 (e.g., a first anode) disposed on a first current collector 1050b1 (e.g., a first anode current collector), a second electrode 1010b1 (e.g., a first cathode) disposed on a first side of a second current collector 1020b. In some embodiments, the second electrochemical cell 1000b further includes a third electrode 1010b2 (e.g., a second cathode) disposed on a second side of the second current collector 1020b, opposite to the first side, and a fourth electrode 1040b2 (e.g., a second anode) disposed on a third current collector 1050b2 (e.g., a second anode current collector). The second electrochemical cell 1000b further includes a first separator 1030b1 disposed between the first electrode 1040b1 and the second electrode 1010b1, and a second separator 1030b2 disposed between the third electrode 1010b2 and the fourth electrode 1040b2. The second electrochemical cell 1000b further includes a plurality of seal members 1060b1, 1060b2, 1060b3, 1060b4, disposed around the first electrode 1040b1, the second electrode 1010b1, the third electrode 1010b2, and the fourth electrode 1040b2, respectively.

In some embodiments, a plurality of seal members 1060a1, 1060a2, 1060a3, 1060a4, 1060b1, 1060b2, 1060b3, 1060b4 (collectively referred to as seal members 1060) are disposed around peripheral edges of the electrochemical cell stack 1000.

In some embodiments, the electrochemical cells 1000a, and 1000b can be same or substantially similar to the electrochemical cells 800a, and 800b, respectively, described above with respect to FIG. 8.

In some embodiments, the electrochemical cell stack 1000 can include an interlayer 1070 disposed between the first electrochemical cell 1000a and the second electrochemical cell 1000b. In some embodiments, the interlayer 1070 may be disposed between the third current collector 1050a2 of the first electrochemical cell 1000a and the first current collector 1050b1 of the second electrochemical cell 1000b.

In some embodiments, the second current collector 1020a of the first electrochemical cell 1000a includes a first tab, and the second current collector 1020b of the second electrochemical cell 1000b includes a second tab. In some embodiments, the first tab and the second tab can be cathode tabs. In some embodiments, as seen in FIG. 10, the first tab and the second (e.g., cathode tabs) can extend out of the electrochemical cell 1000 in a parallel direction with respect to each other. This arrangement can enable the first tab and the second tab to connect with each other such that the first electrochemical cell 800a and the second electrochemical cell 800b can be electrically coupled to each other. In some embodiments, the first tab and the second tab can be coupled to a metal plate 1080 such that the first tab and the second tab is electrically coupled to each other. In some embodiments, the first tab and the second tab can be coupled to a metal plate 1080 such that the first chemical cell 1000a and the second chemical cell 1000b can be coupled in parallel. In some embodiments, the metal plate 1080 can be coupled to a terminal.

In some embodiments, an outer edge of at least one of the current collectors 1050a1, 1020a, 1050a2 of the first electrochemical cell 1000a can extend out the first electrochemical cell 1000a.

In some embodiments, an outer edge of at least one of the current collectors 1050b1, 1020b, 1050b2 of the second electrochemical cell 1000b can extend out of the second electrochemical cell 1000b.

In some embodiments, the electrochemical cell stack 1000 can further include a tab that extends out of the current collectors 1050a1, 1050a2, 1050b1, or 1050b2 such that the tab extends in an opposite direction compared to the first and the second tabs.

In some embodiments, the interlayer 1070 can be selected from at least one of an insulation layer or a heating layer. In some embodiments, the peripheral edges of the interlayer 1070 can extend beyond the third current collector 1050a2 of the first electrochemical cell 1000a and/or the first current collector 1050b1 of the second electrochemical cell 1000b. In some embodiments, the peripheral edges of the interlayer 1070 can extend beyond the seal members 1060. In some embodiments, the interlayer 1070 may be same or substantially similar to the interlayer 770 of FIG. 7.

In some embodiments, the interlayer 1070 may include a tab for electrical connectivity (e.g., voltage and/or current sensing). In some embodiments, the interlayer 1070 may be coupled to other functional parts of a battery system that ensures the safety and/or efficiency of the electrochemical cell stack 1000.

In some embodiments, the fourth electrode 1040a2 of the first electrochemical cell 1000a and the first electrode 1040b1 of the second electrochemical cell 1000b can include an anode. In some embodiments, the third current collector 1050a2 of the first electrochemical cell 1000a can be disposed on the first current collector 1050b1 of the second electrochemical cell 1000b. In some embodiments, the third current collector 1050a2 of the first electrochemical cell 1000a and the first current collector 1050b1 of the second electrochemical cell 1000b can include the same material. For example, in some embodiments, the third current collector 1050a2 of the first electrochemical cell 1000a and the first current collector 1050b1 of the second electrochemical cell 1000b can include copper.

In some embodiments, the second electrodes 1010a1, 1010b1 and the third electrodes 1010a2, 1010b2 of the first 1000a and second 1000b electrochemical cells can include a cathode. In some embodiments, the second current collector 1020a, 1020b of each of the first and second electrochemical cells 1000a, 1000b can include a cathode current collector, and the second current collector 1020a of the first electrochemical cell 1000a can be coupled to the second current collector 1020b of the second electrochemical cell 1000b to electronically couple the first electrochemical cell 1000a to the second electrochemical cell 1000b in parallel. In some embodiments, the anodes and the cathodes can be same or substantially similar to the anodes and the cathodes described above with respect to FIG. 1.

In some embodiments, the second current collector 1020a of the first electrochemical cell 1000a can include aluminum. In some embodiments, the second current collector 1020b of the second electrochemical cell 1000b can include aluminum.

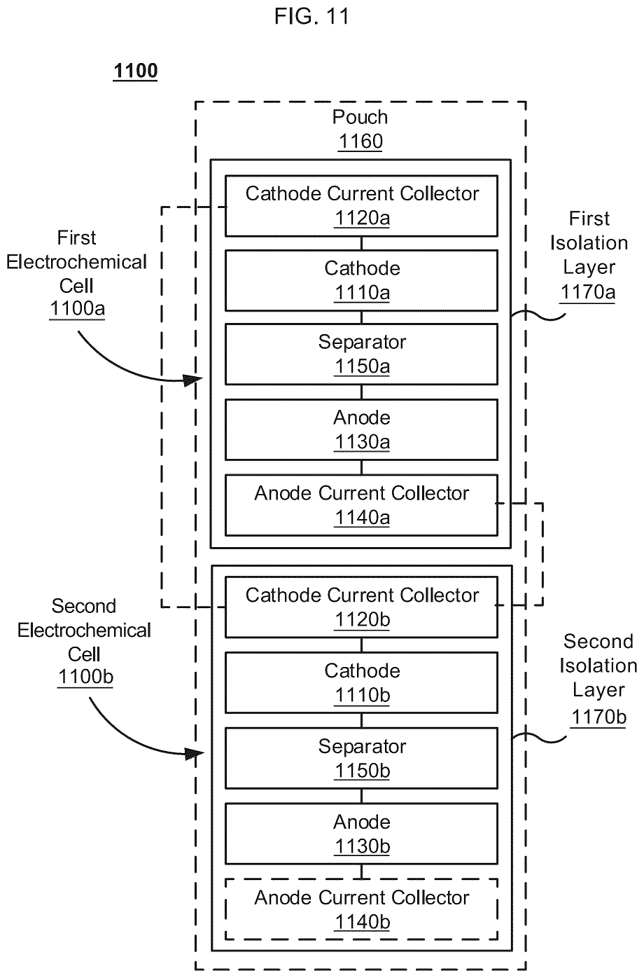

FIG. 11 is a schematic illustration of an electrochemical cell system 1100 including a first electrochemical cell 1100a and a second electrochemical cell 1100b, according to an embodiment.

The first electrochemical cell 1100a includes a first anode 1130a disposed on a first anode current collector 1140a, a first cathode 1110a disposed on a first cathode current collector 1120a, and a first separator 1150a disposed between the first anode 1130a and the first cathode 1110a. The second electrochemical cell 1100b includes a second anode 1130b, a second cathode 1110b disposed on a second cathode current collector 1120b, and a second separator 1150b disposed between the second anode 1130b and the second cathode 1110b. In some embodiments, optionally, the second electrochemical cell 1100b may include a second anode current collector 1140b on which the second anode 1130b is disposed. In some embodiments, the second anode current collector 1140b may be excluded and the second anode 1130b may instead be disposed on the first cathode current collector 1120a, for example, on a surface of the first cathode current collector 1120a that is opposite another surface of the first cathode current collector 1120a on which the first cathode 1110a is disposed. In such embodiments, the first cathode current collector 1120a may serve as a shared current collector used by each of the first cathode 1110a and the second anode 1130b.

In some embodiments, the first electrochemical cell 1100a and the second electrochemical cell 1100b can be disposed in a single pouch 1160. In some embodiments, the electrochemical cell system 1100 includes a first isolation layer 1170a at least partially enclosing the first electrochemical 1100a, and a second isolation layer 1170b at least partially enclosing the second electrochemical cell 1100b to fluidically isolate the first electrochemical cell 1100a from the second electrochemical cell 1100b. In some embodiments, the electrochemical cell system 1100 further includes one or more electrochemical cells electrically connected to the first and the second electrochemical cells 1100a and 1100b.

In some embodiments, the first electrochemical cell 1100a and a second electrochemical cell 1100b can be electrically coupled in series or parallel by direct contact between the respective current collectors (i.e., 1120a, 1140a) of first electrochemical cell 1100a under a compressive force, via welding respective tabs of the current collectors, or via a conductive element that is electrically coupled to (e.g., in physical contact with) the respective current collectors 1120b, 1140b of the second electrochemical cell 1100b.

In some embodiments, coupling the first electrochemical cell 1100a in series with the second electrochemical cell 1100b may enable constant low current charge or discharge.

In some embodiments, coupling the first electrochemical cell 1100a in parallel with the second electrochemical cell 1100b may enable constant low current charge or discharge.

In some embodiments, the first electrochemical cell 1100a may be electrically coupled to the second electrochemical cell 1100b in series. For example, in some embodiments, the electrochemical cell system 1100 is arranged anode-to-cathode in the series configuration, i.e., the anode current collector 1140a of the first electrochemical cell 1100a is electrically coupled to the cathode current collector 1120b of the second electrochemical cell 1100b, or conversely, the cathode current collector 1120a of the first electrochemical 1100a is electrically coupled to the anode current collector 1140b of the second electrochemical cell 1100b, to form a single cell. In embodiments in which the second anode current collector 1140b is not included in the electrochemical cell system 1100, the second anode 1130b may be coupled in series by disposing the second anode 1130b on a second surface of the first cathode current collector 1120a opposite a first surface of the first cathode current collector on which the first cathode 1110a is disposed, or vice versa.

Typical current collectors for lithium cells include copper, aluminum, or titanium for the negative current collector and aluminum for the positive current collector, in the form of sheets or mesh, or any combination thereof. Current collector materials can be selected to be stable at the operating potentials of the positive and negative electrodes of electrochemical cells 1100a and 1100b. For example, in non-aqueous lithium systems, the first cathode current collector 1120a and/or the second cathode current collector 1120b (collectively referred to as “cathode current collectors 1120”) can include aluminum, or aluminum coated with conductive material that does not electrochemically dissolve at operating potentials of 2.5-5.0V with respect to Li/Li. Such materials include platinum, gold, nickel, conductive metal oxides such as vanadium oxide, and carbon. The first anode current collector 1140a and/or the second anode current collector 1140b (collectively referred to as “anode current collectors 1140”) can include copper or other metals that do not form alloys or intermetallic compounds with lithium, carbon, and/or coatings comprising such materials disposed on another conductor.

In some embodiments, the first anode current collector 1140a can include copper and the second anode current collector 1140b can also include copper. In some embodiments, the second cathode current collector 1120b to which the first anode current collector 1140a may be coupled in the series configuration may include aluminum. In some embodiments, the second cathode current collector 1120b may also include copper.

In some embodiments, the first cathode 1110a is disposed on a first side of the first cathode current collector 1120a, and the second anode 1130b may be disposed on a second side of the first cathode current collector 1120a opposite the first side, such that the first cathode current collector 1120a acts as a cathode current collector for the first electrochemical cell 1100a and as an anode current collector for the second electrochemical cell 1100b. In such embodiments, the first anode current collector 1140a may include copper, and the first cathode current collector 1120a may include aluminum, and the second cathode current collector 1120b may include aluminum. In some embodiments, each of the first anode and cathode current collectors 1140a, 1120a, and the second anode and cathode current collector 1140b, 1120b, may include aluminum.

In some embodiments, the isolation layer 1170a and 1170b (collectively referred to as isolation layers 1170) includes polymer materials such as polyethylene terephthalate (PET), polybutylene terephthalate (PBT), nylon, high-density polyethylene (HDPE), oriented polypropylene (o-PP), polyvinyl chloride (PVC), polyimide (PI), polysulfone (PSU), and their combinations. In some embodiments, the isolation layers 170 can have a thickness of about 0.15 mm, about 0.2 mm, or about 0.25 mm, inclusive of all values and ranges therebetween.

In some embodiments, at least a portion of the first isolation layer 1170a that partially encloses the first electrochemical cell 1100a is disposed onto the first cathode current collector 1120a and/or the first anode current collector 1140a and at least a portion of the second isolation layer 1170b that partially encloses the second electrochemical cell 1100b is disposed onto the second cathode current collector 1120b and/or the second anode current collector 1140b. In some embodiments, the isolation layers 1170a, 1170b may have corresponding openings. In such embodiments, the corresponding openings may allow electrical coupling of the first electrochemical cell 1100a with the second electrochemical cell 1100b. Further, such openings may allow the use of shared current collector (not shown in FIG. 11). In such embodiments, the first anode current collector 1140a may be electrically coupled to the second cathode current collector 1120b such that the first electrochemical cell 1100a is coupled to the second electrochemical cell 1100b in series, and the first anode current collector 1140a is electrically coupled to the second cathode current collector 1120b through the corresponding openings of the first isolation layer 1170a and the second isolation layer 1170b. In some embodiments, the first cathode current collector 1120a may be electrically coupled to the second cathode current collector 1120b such that the first electrochemical cell 1100a is coupled to the second electrochemical cell 1100b in parallel, and the first anode current collector 1140a is electrically coupled to the second anode current collector 1140b through the corresponding openings of the first isolation layer 1170a and the second isolation layer 1170b. In some embodiments, the first cathode 1110a is disposed on a first side of the first cathode current collector 1120a, and the second anode 1130b is disposed on a second side of the first cathode current collector 1120a opposite the first side, for example, through the corresponding openings defined in the first isolation layer 1170a and the second isolation layer 1170b.

In some embodiments, the system 1100 may include a conductive element (not shown) disposed within the corresponding openings such that the conductive element is in contact with the first electrochemical cell 1100a and a second electrochemical cell 1100b. That is, the conductive element is configured to extend through the corresponding openings of the first isolation layer 1170a and the second isolation layer 1170b and contact the respective current collectors of the first electrochemical cell 1100a (i.e., 1120a or 1140a) and the second electrochemical cell 1100b (i.e., 1120b or 1140b). For example, conductive elements may be disposed within the corresponding openings of the first isolation layer 1170a and the second isolation layer 1170b to contact the first cathode current collector 1120a and the second cathode current collector 1120b such that the first electrochemical cell 1100a is coupled to the second electrochemical cell 1100b in parallel through the conductive element. In some embodiments, the conductive element may be disposed within the corresponding openings of the first isolation layer 1170a and the second isolation layer 1170b to contact the first anode current collector 1140a and the second cathode current collector 1120b such that the first electrochemical cell 1100a is coupled to the second electrochemical cell 1100b in series through the conductive element.

The conductive element can be formed into any desirable shape, for example, circular, oval, square, rectangular, polygonal, or any other suitable shape, which may correspond to shape of a corresponding shape of the opening defined in the isolation layer 1170a, 1170b. For example, in some embodiments, the conductive element may be in a form of a sheet (e.g., a thin sheet), a layer, a coil, a spring, a porous material (e.g., a foam, a sponge).

In some embodiments, the conductive element can include a metal or metal alloy.

In some embodiments, the conductive element can include a composite material including a polymer and a conductive material. In some embodiments, the polymer can be an elastic polymer (e.g., conductive rubber). In some embodiments, the polymer can be configured to have an electrical resistance above a pre-determined value. In some embodiments, the polymer may include rubber. In some embodiments, the rubber can include at least one of a natural rubber, or a synthetic rubber. In some embodiments, the polymer can include at least one of polyolefin, polyetheretherketone (PEEK), styrene-butadiene rubber (SBR), polyurethane, ethylene propylene diene monomer (EPDM), perfluoroalkoxy (PFA), polyvinylidene fluoride (PVDF), polytetrafluoroethylene (PTFE), or similar polymer. In some embodiments, the conductive material can include a carbon-based material. In some embodiments, the conductive material can include at least one of graphite, graphene, carbon black, acetylene black, KETJEN BLACK™ carbon particles, carbon fibers, or metals such as copper, nickel, aluminum, gold, platinum, stainless steel, or titanium.

In some embodiments, the conductive material can include at least one of nanotubes, nanoparticles, and/or microspheres.

In some embodiments, the conductive element can be in a form of a porous material (e.g., a mesh or a sponge). In some embodiments, the conductive element can be in a form of a sponge. In some embodiments, the conductive element can include an elastic polymer (e.g., a rubber). In some embodiments, the conductive element can include a polymer that is configured to be in a form of at least one of a sponge or a rubber material and a conductive material. In some embodiments, in order to obtain such a composite material, a conductive material (e.g., carbon-based material or a metal) in a powder form can be mixed with a polymer material (e.g., rubber). In some embodiments, a carbon sheet can be combined with a polymer material (e.g., a rubber) to obtain the conductive element. That is, in some embodiments, the conductive element can include a carbon fiber sheet and a polymer material. In some embodiments, the conductive element can include a carbon fiber sheet and a polymer material that forms rubber (i.e., rubber material). In some embodiments, the conductive element can include a polytetrafluoroethylene (PTFE) (i.e., TEFLON™) fiber sheet coated with a metal or carbon layer.

In some embodiments, the conductive element can be in a form of a sponge, a foam, a rubber, or a rubber-like material. That is, in some embodiments, the conductive element can include a polymer that results in formation of a sponge, a foam, a rubber, or a rubber-like material.

In some embodiments, the conductive element can have a thickness of at least about 3 μm, at least about 5 μm, at least about 7 μm, at least about 10 μm, at least about 15 μm, at least about 20 μm, at least about 25 μm, at least about 30 μm, at least about 35 μm, at least about 40 μm, at least about 45 μm, at least about 50 μm, at least about 55 μm, at least about 60 μm, at least about 65 μm, or at least about 70 μm, in an uncompressed configuration, i.e., when no pressure is exerted on the conductive element. In some embodiments, the conductive element can have a thickness of no more than about 1100 μm, no more than about 95 μm, no more than about 90 μm, no more than about 85 μm, no more than about 80 μm, no more than about 75 μm, no more than about 70 μm, no more than about 65 μm, no more than about 60 μm, no more than about 55 μm, no more than about 50 μm, no more than about 45 μm, no more than about 40 μm, no more than about 35 μm, or no more than about 30 μm in the uncompressed configuration. Combinations of the above-referenced thicknesses are also possible (e.g., at least about 3 μm and no more than about 1100 μm or at least about 7 μm and no more than about 70 μm), inclusive of all values and ranges therebetween. In some embodiments, the thickness of the conductive element is determined without applying any pressure exceeding about 0.2 bar, such as a stacking pressure, onto the element. In some embodiments, the thickness corresponds to the thickness of the conductive element before its integration into system 1100.

In some embodiments, the conductive element can have a thickness of at least about 2 μm, at least about 6 μm, at least about 8 μm, at least about 10 μm, at least about 15 μm, at least about 20 μm, at least about 25 μm, at least about 30 μm, at least about 35 μm, at least about 40 μm, at least about 45 μm, or at least about 50 μm, under a stack pressure (e.g., a stack pressure). In some embodiments, the conductive element can have a thickness of no more than about 80 μm, no more than about 95 μm, no more than about 90 μm, no more than about 85 μm, no more than about 80 μm, no more than about 75 μm, no more than about 70 μm, no more than about 65 μm, no more than about 60 μm, no more than about 55 μm, no more than about 50 μm, no more than about 45 μm, no more than about 40 μm, no more than about 35 μm, or no more than about 30 μm under a pressure. Combinations of the above-referenced thicknesses are also possible (e.g., at least about 2 μm and no more than about 80 μm or at least about 8 μm and no more than about 50 μm), inclusive of all values and ranges therebetween. In some embodiments, the thickness of the conductive element is measured under a pressure (e.g., a stack pressure) ranging from about 0.2 bar to about 7.0 bar. In some embodiments, the thickness of the conductive element may be reduced by applying pressure, by at least about 1%, at least about 3%, at least about 5%, at least about 7%, at least about 10%, at least about 15%, at least about 20%, at least about 25%, at least about 30%, at least about 35%, at least about 40%, at least about 45%, or at least about 50% of its thickness measured in a non-pressurized environment.

In some embodiments, when the electrochemical cell 1100a and electrochemical cell 1100b are under operation, the thickness of the conductive element may further decrease due to i) being under a stack pressure; and/or ii) the swelling of the electrochemical cells 1100a and 1100b.

In some embodiments, the conductive element can include a conductive adhesion layer disposed on a polymeric material (e.g., rubber) to partially or entirely cover the conductive material, for example, to provide a conductive pathway around the polymeric material on which the conductive adhesive is disposed. In some embodiments, a conductive adhesion layer can be disposed onto a first end of the conductive material, which is in contact with a respective current collector material 1120a, 1140a of first electrochemical cell 1100a, and onto a second end of the conductive material, opposite to the first end, that is in contact with the respective current collector 1120b, 1140b of the second electrochemical cell 1100b.

In some embodiments, when the electrochemical cell 1100a and electrochemical cell 1100b are under operation, the thickness of the conductive element can further decrease to a thickness of at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 15 μm, at least about 20 μm, at least about 25 μm, at least about 30 μm, at least about 35 μm, at least about 40 μm, at least about 45 μm, or at least about 50 μm, under a pressure (e.g., a stack pressure). In some embodiments, the conductive element can have a thickness of no more than about 80 μm, no more than about 95 μm, no more than about 90 μm, no more than about 85 μm, no more than about 80 μm, no more than about 75 μm, no more than about 70 μm, no more than about 65 μm, no more than about 60 μm, no more than about 55 μm, no more than about 50 μm, no more than about 45 μm, no more than about 40 μm, no more than about 35 μm, or no more than about 30 μm under a pressure. Combinations of the above-referenced thicknesses are also possible (e.g., at least about 2 μm and no more than about 80 μm or at least about 8 μm and no more than about 50 μm), inclusive of all values and ranges therebetween.

In some embodiments, a reduction in thickness of the conductive element during operation, for example, due to pressure being exerted on the conductive element and/or swelling of the electrochemical cell, may be based on the composition of the electrochemical cell. In some embodiments, the electrochemical cell may include a conventional cathode (e.g., a lithium ion cathode) and a lithium metal anode. In such embodiments, the thickness of the conductive element during operation may be in a range of between about 1 μm to about 70 μm, inclusive, for example, at least about 1 μm, at least about 5 μm, at least about 10 μm, at least about 15 μm, at least about 20 μm, at least about 30 μm, at least about 40 μm, at least about 50 μm, or at least about 60 μm. In some embodiments, the thickness of the conductive element of such an electrochemical cell is no more than about 70 μm, no more than about 60 μm, no more than about 50 μm, no more than about 40 μm, no more than about 30 μm, no more than about 20 μm, or no more than about 10 μm. Combinations of the above-referenced thicknesses are also possible (e.g., at least about 2 μm and no more than about 70 μm or at least about 6 μm and no more than about 45 μm), inclusive of all values and ranges therebetween.

In some embodiments, the electrochemical cell may include a semi-solid cathode (e.g., any of the semi-solid cathodes described herein). In such embodiments, the thickness of the conductive element during operation may be in a range of between about 3 μm to about 90 μm, inclusive, for example, at least about 3 μm, at least about 5 μm, at least about 10 μm, at least about 15 μm, at least about 20 μm, at least about 30 μm, at least about 40 μm, at least about 50 μm, at least about 60 μm, at least about 70 μm, at least about 80 μm, or at least about 90 μm. In some embodiments, the thickness of the conductive element of such an electrochemical cell is no more than about 90 μm, no more than about 80 μm, no more than about 70 μm, no more than about 60 μm, no more than about 50 μm, no more than about 40 μm, no more than about 30 μm, no more than about 20 μm, or no more than about 10 μm. Combinations of the above-referenced thicknesses are also possible (e.g., at least about 2 μm and no more than about 80 μm or at least about 8 μm and no more than about 60 μm), inclusive of all values and ranges therebetween.

In some embodiments, the first anode 1130a and/or the second anode 1130b can be a semi-solid electrode. In some embodiments, the first cathode 1110a and/or the second cathode 1110b can be a semi-solid electrode. In comparison to conventional electrodes, semi-solid electrodes can be made (i) thicker (e.g., greater than about 250 μm-up to about 2,000 μm or even greater) due to the reduced tortuosity and higher electronic conductivity of semi-solid electrodes, (ii) with higher loadings of active materials, (iii) with a simplified manufacturing process utilizing less equipment, and (iv) can be operated between a wide range of C-rates while maintaining a substantial portion of their theoretical charge capacity. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein, are binderless and/or do not use binders that are used in conventional battery manufacturing. Instead, the volume of the electrode normally occupied by binders in conventional electrodes, is now occupied, by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes.

Since the semi-solid electrodes described herein can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This may substantially increase the overall charge capacity and energy density of a battery that includes the semi-solid electrodes described herein. The use of semi-solid, binderless electrodes can also be beneficial in the incorporation of an overcharge protection mechanism, as generated gas can migrate to the electrode/current collector interface without binder particles inhibiting the movement of the gas within the electrode.

In some embodiments, the electrode materials described herein can be a flowable semi-solid or condensed liquid composition. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in a liquid electrolyte to produce a semi-solid electrode. Examples of electrochemical cells that include a semi-solid and/or binderless electrode material are described in U.S. Pat. No. 8,993,159 entitled, “Semi-solid Electrodes Having High Rate Capability,” registered Mar. 31, 2015 (“the '159 patent”), the disclosure of which is hereby incorporated herein by reference in its entirety.

In some embodiments, the first electrochemical cell 1100a and/or the second electrochemical cell 1100b can include conventional electrodes (e.g., solid electrodes with binders). In some embodiments, the thickness of the conventional electrodes can be in the range of about 20 μm to about 100 μm, about 20 μm to about 90 μm, about 20 μm to about 80 μm, about 20 μm to about 70 μm, about 20 μm to about 60 μm, about 25 μm to about 60 μm, about 30 μm to about 60 μm, about 20 μm to about 55 μm, about 25 μm to about 55 μm, about 30 μm to about 55 μm, about 20 μm to about 50 μm, about 25 μm to about 50 μm, or about 30 μm to about 50 μm, inclusive of all values and ranges therebetween. In some embodiments, the thickness of the conventional electrodes can be about 20 μm, about 25 μm, about 30 μm, about 35 μm, about 40 μm, about 45 μm, about 50 μm, about 55 μm, or about 60 μm, inclusive of all values and ranges therebetween.

In some embodiments, the first anode 1130a and/or the second anode 1130b can have a thickness of at least about 20 μm, at least about 30 μm, at least about 40 μm, at least about 50 μm, at least about 60 μm, at least about 70 μm, at least about 80 μm, at least about 90 μm, at least about 100 μm, at least about 110 μm, at least about 120 μm, at least about 130 μm, or at least about 140 μm. In some embodiments, the first anode 1130a and/or the second anode 1130b can have a thickness of no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, no more than about 60 μm, no more than about 50 μm, or no more than about 30 μm. Combinations of the above-referenced thicknesses of the first anode 1130a and/or the second anode 1130b are also possible (e.g., at least about 20 μm and no more than about 150 μm or at least about 50 μm and no more than about 100 μm), inclusive of all values and ranges therebetween. In some embodiments, the first anode 1130a and/or the second anode 1130b can have a thickness of about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, or about 15 μm.

In some embodiments, the second anode 1130b can have a thickness the same or substantially similar to a thickness of the first anode 1130a. In some embodiments, the second anode 1130b can have a thickness greater than the thickness of the first anode 1130a. In some embodiments, the second anode 1130b can be thicker than the first anode 1130a by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the first cathode 1110a and/or the second cathode 1110b can have a thickness of at least about 50 μm, at least about 60 μm, at least about 70 μm, at least about 80 μm, at least about 90 μm, at least about 100 μm, at least about 110 μm, at least about 120 μm, at least about 130 μm, at least about 140 μm, at least about 150 μm, at least about 200 μm, at least about 250 μm, at least about 300 μm, at least about 350 μm, at least about 400 μm, or at least about 450 μm. In some embodiments, the first cathode 1110a and/or the second cathode 1110b can have a thickness of no more than about 500 μm, no more than about 450 μm, no more than about 400 μm, no more than about 350 μm, no more than about 300 μm, no more than about 250 μm, no more than about 200 μm, no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, or no more than about 60 μm. Combinations of the above-referenced thicknesses of the first cathode 1110a and/or the second cathode 1110b are also possible (e.g., at least about 50 μm and no more than about 500 μm or at least about 100 μm and no more than about 300 μm), inclusive of all values and ranges therebetween. In some embodiments, the first cathode 1110a and/or the second cathode 1110b can have a thickness of about 50 μm, about 60 μm, about 70 μm, about 80 μm, about 90 μm, about 100 μm, about 110 μm, about 120 μm, about 130 μm, about 140 μm, about 150 μm, about 200 μm, about 250 μm, about 300 μm, about 350 μm, about 400 μm, about 450 μm, or about 500 μm.

In some embodiments, the second cathode 1110b can have a thickness the same or substantially similar to a thickness of the first cathode 1110a. In some embodiments, the second cathode 1110b can have a thickness greater than the thickness of the first cathode 1110a. In some embodiments, the second cathode 1110b can be thicker than the first cathode 1110a by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the first electrochemical cell 1100a and/or the second electrochemical cell 1100b can have a thickness of at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, or at least about 950 μm. In some embodiments, the first electrochemical cell 1100a and/or the second electrochemical cell 1100b can have a thickness of no more than about 1,000 μm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, or no more than about 150 μm. Combinations of the above-referenced thicknesses of the first electrochemical cell 1100a and/or the second electrochemical cell 1100b are also possible (e.g., at least about 100 μm and no more than about 1,000 μm or at least about 200 μm and no more than about 500 μm), inclusive of all values and ranges therebetween. In some embodiments, the first electrochemical cell 1100a and/or the second electrochemical cell 1100b can have a thickness of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, or about 1,000 μm.

In some embodiments, the second electrochemical cell 1100b can have a thickness the same or substantially similar to a thickness of the first electrochemical cell 1100a. In some embodiments, the second electrochemical cell 1100b can have a thickness greater than the thickness of the first electrochemical cell 1100a. In some embodiments, the second electrochemical cell 1100b can be thicker than the first electrochemical cell 1100a by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the electrochemical cell system 1100 can include a third electrochemical cell (not shown). In some embodiments, the electrochemical cell system 1100 can include 4, 5, 6, 7, 8, 9, 10 or more electrochemical cells. In some embodiments, a selection of many different battery properties can be combined into the electrochemical cell system 1100 in order to manipulate the performance properties of the electrochemical cell system 1100 as desired.

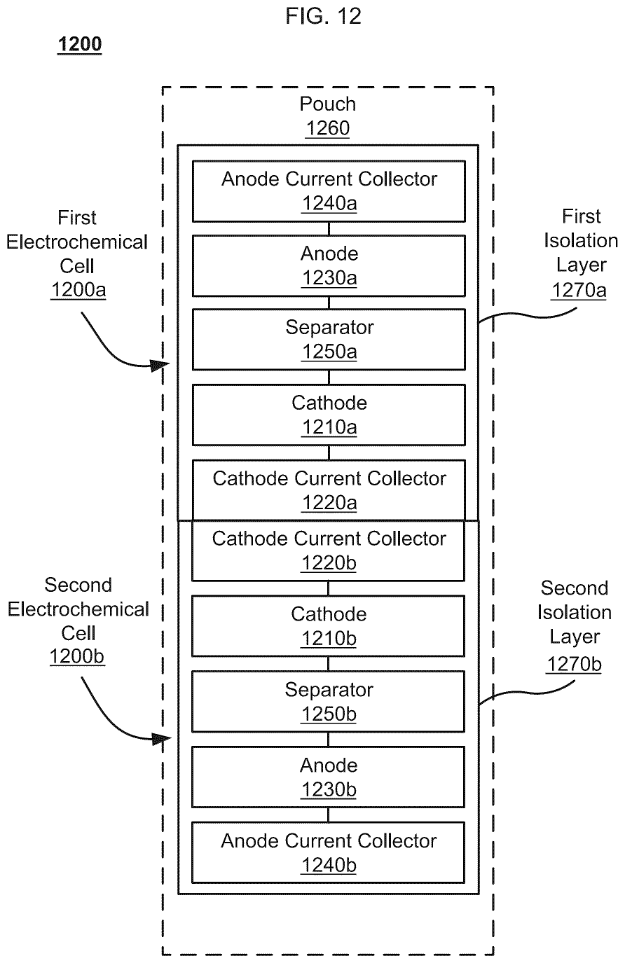

FIG. 12 is a schematic illustration of an electrochemical cell system 1200 including a first electrochemical cell 1200a and a second electrochemical cell 1200b arranged cathode-to-cathode, i.e., the cathode current collector 1220a of the first electrochemical cell 1200a is electrically coupled to the cathode current collector 1220b of the second electrochemical cell 1200b in a parallel, according to an embodiment. Although the electrochemical cell system 1200 is arranged cathode-to-cathode in the parallel configuration this is only for illustrative purposes and the anode current collectors 1240a and 1240b may alternatively be electrically coupled to each other, to form a single cell system. In some embodiments, the first electrochemical cell 1200a and a second electrochemical cell 1200b can be electrically coupled in parallel by direct contact between the respective current collectors (i.e., 1220a and 1220b or 1240a and 1240b) under a compressive force, via welding respective tabs of the current collectors, or via a conductive element that is electrically coupled to (e.g., in physical contact with) the respective current collectors. In some embodiments, the first electrochemical cell 1200a and the second electrochemical cell 1200b can be the same or substantially similar to the first electrochemical cell 1100a and the second electrochemical cell 1100b as described above with reference to FIG. 11. Connecting two such cells in parallel can deliver high power density or high energy density on demand.

In some embodiments, the first electrochemical cell 1200a and the second electrochemical cell 1200b can be disposed in a single pouch 1260. In some embodiments, the electrochemical cell system 1200 includes a first isolation layer 1270a at least partially enclosing the first electrochemical cell 1200a, and a second isolation layer 1270b at least partially enclosing the second electrochemical cell 1200b to fluidically isolate the first electrochemical cell 1200a from the second electrochemical cell 1200b. In some implementations, corresponding openings may be provided in the first isolation layer 1270a and the second isolation layer 270b through which the cathode current collector 1220a may be electrically coupled to the cathode current collector 1220b in a parallel configuration. In some embodiments, the electrochemical cell system 1200 further includes one or more electrochemical cells electrically connected to the first and the second electrochemical cells 1200a and 1200b. In some embodiments, the first isolation layer 1270a may also be coupled to the second isolation layer 1270b (e.g., via heat sealing or adhesives) to secure the first electrochemical cell 1200a to the second electrochemical cell 1200b.

In some embodiments, the system 1200 can include a conductive element as described as described above with reference to FIG. 11. In some embodiments, the conductive element (not shown) can be disposed within the corresponding openings defined in the isolation layers 1270a, 1270b such that the conductive element becomes in contact with the cathode current collector 1220a of the first electrochemical cell 1200a, and the cathode current collector 1220b of the second electrochemical cell 1200b. In some embodiments, the conductive material includes a composite material including a polymer material that is in a form of a sponge or a rubber and a conductive material selected from at least one of graphite, graphene, carbon black, acetylene black, KETJEN BLACK™ conductive carbon particles, carbon fibers, metals such as copper, nickel, aluminum, gold, platinum, stainless steel, or titanium.

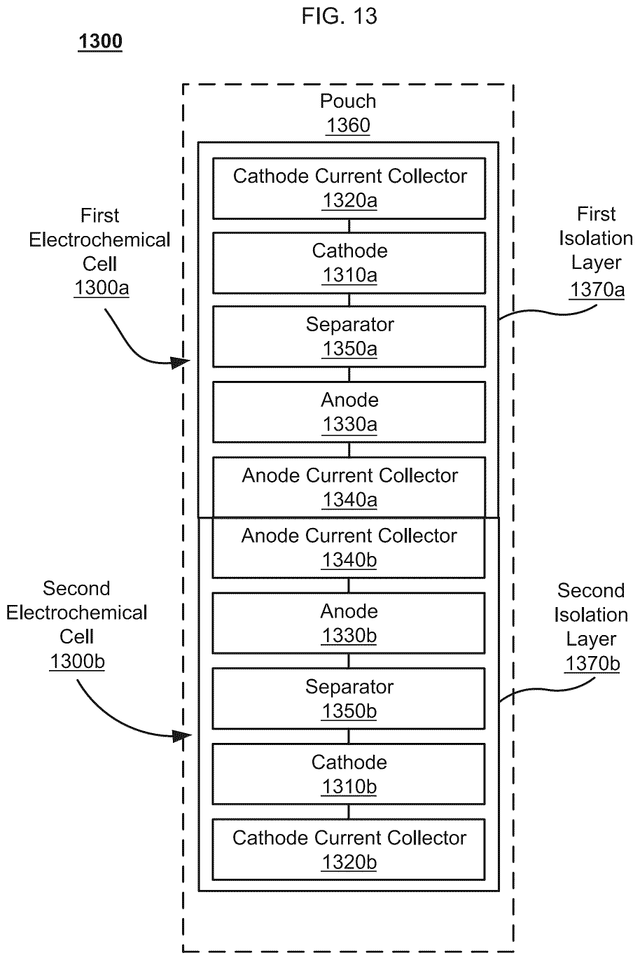

FIG. 13 is a schematic illustration of an electrochemical cell system 1300 including a first electrochemical cell 1300a and a second electrochemical cell 1300b arranged anode-to-anode i.e., the anode current collector 1340a of the first electrochemical cell 1300a is electrically coupled to the anode current collector 1340b of the second electrochemical cell 1300b in parallel, according to an embodiment. In some embodiments, the first electrochemical cell 1300a and a second electrochemical cell 1300b can be electrically coupled in parallel by direct contact between the respective current collectors (i.e., 1340a and 1340b) under a compressive force, via welding respective tabs of the current collectors, or via a conductive element that is electrically coupled to (e.g., in physical contact with) the respective current collectors 1340a, 1340b. In some embodiments, the first electrochemical cell 1300a and the second electrochemical cell 1300b can be the same or substantially similar to the first electrochemical cell 1100a and the second electrochemical cell 1100b as described above with reference to FIG. 11.

In some embodiments, the first electrochemical cell 1300a and the second electrochemical cell 1300b can be disposed in a single pouch 1360. In some embodiments, the electrochemical cell system 1300 includes a first isolation layer 1370a at least partially enclosing the first electrochemical cell 1300a, and a second isolation layer 1370b at least partially enclosing the second electrochemical cell 1300b to fluidically isolate the first electrochemical cell 1300a from the second electrochemical cell 1300b. In some implementations, corresponding openings may be provided in the first isolation layer 1370a and the second isolation layer 1370b through which the anode current collector 1340a may be electrically coupled to the anode current collector 1340b in a parallel configuration. In some embodiments, the electrochemical cell system 1300 further includes one or more electrochemical cells electrically connected to the first and the second electrochemical cells 1300a and 1300b. In some embodiments, the first isolation layer 1370a may also be coupled to the second isolation layer 1370b (e.g., via heat sealing or adhesives) to secure the first electrochemical cell 1300a to the second electrochemical cell 1300b.

In some embodiments, the system 1300 can include a conductive element as described as described above with reference to FIG. 11. In some embodiments, the conductive element (not shown) can be disposed within the corresponding openings defined in the isolation layers 1370a, 1370b such that the conductive element comes in contact with the anode current collector 1340a of the first electrochemical cell 1300a, and the anode current collector 1340b of the second electrochemical cell 1300b. In some embodiments, the conductive material includes a composite material including a polymer material that is in a form of a sponge or a rubber and a conductive material selected from at least one of graphite, graphene, carbon black, acetylene black, KETJEN BLACK™ conductive carbon particles, carbon fibers, metals such as copper, nickel, aluminum, gold, platinum, stainless steel, or titanium.

In various embodiments, an electrochemical cell stack can include unit bi-cells (e.g., systems 1200, and 1300) stacked on top of each other, i.e., electrochemical cells that each include more than one anode and/or cathode. Such electrochemical unit bi-cells can be stacked on top of each other in any suitable configuration to form an electrochemical cell stack, with the electrochemical unit bi-cells being electrically coupled to each other in series or in parallel.

In such embodiments, the outer most current collectors (e.g., anode or cathode current collectors) may be accessible through openings defined in a pouch or isolation layer, and a conductive element (e.g., any of the conductive elements described herein) may be disposed in the corresponding openings to allow electrical coupling with the outer most current collectors via the conductive element so that a tab extending from the outer most current collectors is not used. Similarly, current collectors of adjacent cells in the stack may also be coupled to each other (e.g., anode to anode or anode to cathode) through a conductive element disposed through corresponding openings defined in isolations layers. Such bi-cells may include a double sided anode current collector having anode material disposed on both side thereof, or a cathode current collector having cathode material disposed on both sides thereof. Since such a double side current collector would generally be a middle layer of its respective electrochemical cell included in the bi-cell such that it would not be accessible via a conductive element. A tab may extend from each of the double sided current collectors, and the respective tabs of the double sided current collectors of the bi-cells may be coupled to each other to couple the two electrochemical cells included in the bi-cell in series (cathode current collector to anode current collector or vice versa) or in parallel (cathode current collector to cathode current collector or anode current collector to anode current collector). Coupling the two tabs results in only a single tab extending outwards from the electrochemical cell stack, thus reducing the total numbers of tabs extending from such electrochemical cells. This provides the benefit of reducing the number of current collector tabs, allowing more space to be occupied by the active components of the stack, and reducing stack size and complexity. Moreover, larger connections can be made by allowing electrical coupling via conductive elements through openings in the isolation layers or pouch, and allowing isolation layers to be made thinner, thus further reducing size of the stack.

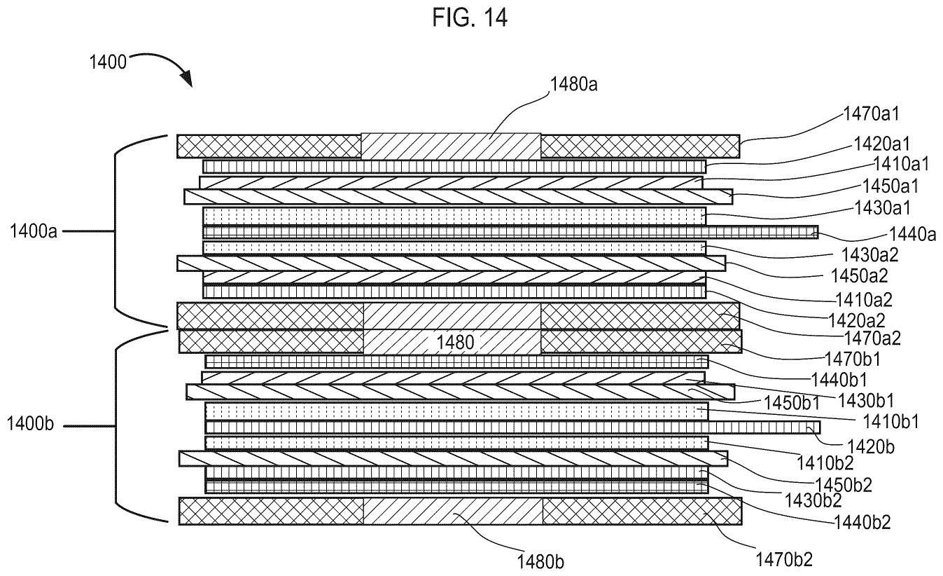

For example, FIG. 14 shows a schematic illustration of an electrochemical cell system 1400, according to an embodiment. The electrochemical cell system 1400 includes a first electrochemical cell 1400a and a second electrochemical cell 1400b electrically coupled to the first electrochemical cell 1400a. In some embodiments, the first electrochemical cell 1400a can be the same or substantially similar to the system (i.e., unit bi-cell) 1300 as described above with reference to FIG. 13. In some embodiments, the second electrochemical cell 1400b can be the same or substantially similar to the system (i.e., unit bi-cell) 1200 as described above with reference to FIG. 12.

The electrochemical cell system 1400 includes a first electrochemical cell 1400a and a second electrochemical cell 1400b, according to an embodiment. In some embodiments, the first electrochemical cell 1400a is a bi-cell that includes a first electrode 1410a1 (e.g., a first cathode) disposed on a first current collector 1420a1 (e.g., a first cathode current collector), a second electrode 1430a1 (e.g., a first anode) disposed on a first side of a second current collector 1440a (e.g., an anode current collector). The first electrochemical cell 1400a further includes a third electrode 1430a2 (e.g., a second anode) disposed on a second side of the second current collector 1440a, opposite to the first side, and a fourth electrode 1410a2 (e.g., a second cathode) disposed on a third current collector 1420a2 (e.g., a second cathode current collector). The first electrochemical cell 1400a may further include a first separator 1450a1 disposed between the first electrode 1410a1 and the second electrode 1430a1, and a second separator 1450a2 disposed between the third electrode 1430a2 and the fourth electrode 1410a2.

In some embodiments, the second electrochemical cell 1400b is a bi-cell that includes a first electrode 1430b1 (e.g., a first anode) disposed on a first current collector 1440b1 (e.g., a first anode current collector), a second electrode 1410b1 (e.g., a first cathode) disposed on a first side of a second current collector 1420b (e.g., a cathode current collector). The first electrochemical cell 1400b further includes a third electrode 1410b2 (e.g., a second cathode) disposed on a second side of the second current collector 1420b, opposite to the first side, and a fourth electrode 1430b2 (e.g., a second anode) disposed on a third current collector 1430b2 (e.g., a second anode current collector). The second electrochemical cell 1400b may further include a first separator 1450b1 disposed between the first electrode 1440b1 and the second electrode 1410b2, and a second separator 1450b2 disposed between the third electrode 1410b2 and the fourth electrode 1430b2.

The first electrochemical cell 1400a may further include a first isolation layer including a first portion 1470a1 and a second portion 1470a2 coupled to each other to form a first volume at least partially enclosing the first electrochemical cell 1400a. Similarly, the second electrochemical cell 1400b also includes a second isolation layer including a first portion 1470b1 and a second portion 1470b2 coupled to each other to form a second volume at least partially enclosing the second electrochemical cell 1400b.

In some embodiments, the second portion 1470a2 of the first isolation layer and the first portion 1470b1 of the second isolation layer which face each other may have corresponding openings (not shown), through which the third current collector 1420a2 of 1400a and the first current collector 1440b1 of 1400b may be physically and electrically coupled to each other, thereby coupling the first electrochemical cell 1400a and the second electrochemical cell 1400b in series. In some embodiments, the first portion 1470a1 of the first isolation layer and the second portion 1470b1 of the second isolation layer, which are located on opposite ends of the system 1400 may also have corresponding openings (not shown).

In some embodiments, the system 1400 can include a plurality of conductive elements (e.g., metal, composite, conductive polymer, etc.) (1480a, 1480, 1480b) as described with respect to FIG. 11. In some embodiments, the conductive elements 1480, 1480a, 1480b can extend through the corresponding openings of the isolation layers 1470a1, 1470a2, 1470b1, 1470b2. In some embodiments, the conductive element 1480 may disposed through corresponding openings defined in isolation layers 1470a2 and 1470b1 to couple the third current collector 1420a2 of the first electrochemical cell 1400a to the first current collector 1440b1 of the second electrochemical cell 1400b.

In some embodiments, the conductive elements 1480, 1480a, 1480b may include a conductive paste that includes a slurry or high viscosity solution that is disposed in the corresponding openings. In some embodiments, the conductive elements 1480, 1480a, 1480b may include an adhesive tape, or a conductive member that is electrically coupled to the exposed portion of the corresponding current collector 1420a1, 1420a2, 1440b1, 1440b2 can be via a mechanical connection due to a compressive force (e.g., exerted by a biasing member or compressing structure, or due to stack pressure), welding, fusion bonding, bonding via conductive adhesive, etc. In some embodiments, the conductive elements 1480, 1480a, 1480b can be any conductive element as described with respect to the system 1100.

In some embodiments, disposing of the conductive element 1480 in the openings defined by the second portion 1470a2 of the first isolation layer, and the first portion 1470b1 of the second isolation layer may cause a gap to occur between the second portion 1470a2 of the first isolation layer and the first portion 1470b1 of the second isolation layer, for example, due to a thickness of the conductive element 1480 being larger than a total thickness of the second portion 1470a2 of the first isolation layer and the first portion 1470b1 of the second isolation layer. In such embodiments, the conductive element 1480 may be sufficiently constrained or under sufficient pressure to compress the conductive element 1480 to reduce its thickness to be substantially equal to the total thickness of the second portion 1470a2 of the first isolation layer and the first portion 1470b1 of the second isolation layer.

In some embodiments, instead of having a conductive element 1480 that is disposed through openings defined in each of the second portion 1470a2 of the first isolation layer and the first portion 1470b1 of the second isolation layer, one of the second portion 1470a2 of the first isolation layer or the first portion 1470b1 of the second isolation layer may be formed from a material that is electron conductive, but electrolyte impermeable (e.g., formed from metals, conductive polymers, carbon, graphite, any other material, or any suitable combination thereof). In such embodiments, the electron conductive but electrolyte impermeable second portion 1470a2 of the first isolation layer or the first portion 1470b1 of the second isolation layer may define an opening such that conductive element 1480 is disposed in an opening defined in the electronically insulative one of second portion 1470a2 of the first isolation layer or the first portion 1470b1 of the second isolation layer and contacts the corresponding electron conductive but electrolyte impermeable second portion 1470a2 of the first isolation layer or the first portion 1470b1 of the second isolation layer to form a series connection therebetween.

In some embodiments, the first electrochemical cell 1400a and the second electrochemical cell 1400b can be electrically coupled through tabs extending from suitable current collectors. For example, a first tab extending from the second current collector 1440a (e.g., an anode current collector) of the first electrochemical cell 1400a can be coupled to a second tab extending from the second current collector 1420b (e.g., a cathode current collector) of the second electrochemical cell 1400b to couple the first electrochemical cell 1400a to the second electrochemical cell 1400b in series. The tabs can be coupled to a voltage source, a voltage measurement point, a diode, a resistor, a transistor, a fuse, or any combination thereof.

This design allows use of a single tab for the system 1400. By reducing one tab compared to conventional two tab designs, the space is effectively utilized, allowing incorporation of additional tabs (e.g., tabs corresponding to interlayers disposed within or associated with separators or voltage sensing tabs).

In some embodiments, the first electrochemical cell 1400a and the second electrochemical cell 1400b can be disposed in a single pouch.

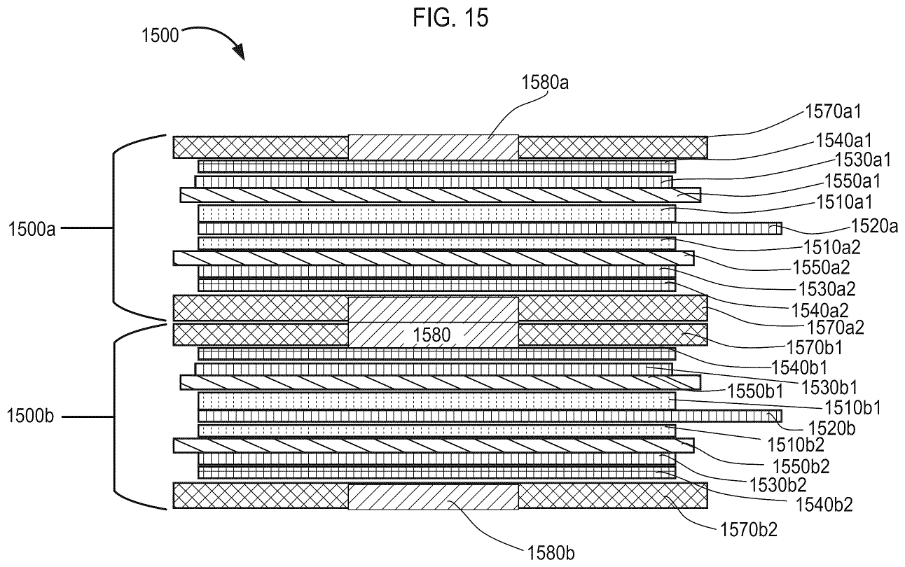

FIG. 15 shows a block diagram of an electrochemical cell system 1500, according to an embodiment. The electrochemical cell system 1500 includes a first electrochemical cell 1500a and a second electrochemical cell 1500b electrically coupled to the first electrochemical cell 1500a. In some embodiments, the first electrochemical cell 1500a and the second electrochemical cell 1500b can be the same or substantially similar to the system (i.e., unit bi-cell) 1200 as described above with reference to FIG. 12.

The electrochemical cell system 1500 includes a first electrochemical cell 1500a and a second electrochemical cell 1500b, according to an embodiment. In some embodiments, the first electrochemical cell 1500a is a bi-cell that includes a first electrode 1530a1 (e.g., a first anode) disposed on a first current collector 1540a1 (e.g., a first anode current collector), a second electrode 1510a1 (e.g., a first cathode) disposed on a first side of a second current collector 1520a (e.g., a cathode current collector). The first electrochemical cell 1500a further includes a third electrode 1510a2 (e.g., a second cathode) disposed on a second side of the second current collector 1520a, opposite to the first side, and a fourth electrode 1530a2 (e.g., a second anode) disposed on a third current collector 1540a2 (e.g., a second anode current collector). The first electrochemical cell 1500a may further include a first separator 1550a1 disposed between the first electrode 1530a1 and the second electrode 1510a1, and a second separator 1550a2 disposed between the third electrode 1510a2 and the fourth electrode 1530a2.

In some embodiments, the second electrochemical cell 1500b is a bi-cell that includes a first electrode 1530b1 (e.g., a first anode) disposed on a first current collector 1540b1 (e.g., a first anode current collector), a second electrode 1510b1 (e.g., a first cathode) disposed on a first side of a second current collector 1520b (e.g., a cathode current collector). The first electrochemical cell 1500b further includes a third electrode 1510b2 (e.g., a second cathode) disposed on a second side of the second current collector 1520b, opposite to the first side, and a fourth electrode 1530b2 (e.g., a second anode) disposed on a third current collector 1540b2 (e.g., a second anode current collector). The first electrochemical cell 1500b may further include a first separator 1550b1 disposed between the first electrode 1530b1 and the second electrode 1510b1, and a second separator 1550b2 disposed between the third electrode 1510b2 and the fourth electrode 1530b2.

The first electrochemical cell 1500a may further include a first isolation layer including a first portion 1570a1 and a second portion 1570a2 coupled to each other to form a first volume at least partially enclosing the first electrochemical cell 1500a. Similarly, the second electrochemical cell 1500b also includes a second isolation layer including a first portion 1570b1 and a second portion 1570b2 coupled to each other to form a second volume at least partially enclosing the second electrochemical cell 1500b.

In some embodiments, the second portion 1570a2 of the first isolation layer and the first portion 1570b1 of the second isolation layer which face each other may have corresponding openings (not shown), through which the third current collector 1540a2 of the first electrochemical cell 1500a and the first current collector 1540b1 of the electrochemical cell 1500b may be physically and electrically coupled to each other. In some embodiments, the first portion 1570a1 of the first isolation layer and the second portion 1570b1 of the second isolation layer, which are located on opposite ends of the system 1500 may also have corresponding openings (not shown).

In some embodiments, the system 1500 can include a plurality of conductive elements (e.g., metal, composite, conductive polymer, etc.) (1580a, 1580, 1580b) as described with respect to FIG. 11. In some embodiments, the conductive elements 1580 can extend through the corresponding openings of the isolation layers 1570a1, 1570a2, 1570b1, 1570b2. In some embodiments, the conductive element 1580 may be in contact with the third current collector 1540a2 of the first electrochemical cell 1500a and the first current collector 1540b1 of the second electrochemical cell 1500b.

In some embodiments, the conductive elements 1580, 1580a, 1580b may include a conductive paste that includes a slurry or high viscosity solution that is disposed in the corresponding openings. In some embodiments, the conductive elements 1580, 1580a, 1580b may include an adhesive tape, or a conductive member that is electrically coupled to the exposed portion of the corresponding current collector 1540a1, 1540a2, 1540b1, 1540b2 can be via a mechanical connection due to a compressive force (e.g., exerted by a biasing member or compressing structure, or due to stack pressure), welding, fusion bonding, bonding via conductive adhesive, etc. In some embodiments, the conductive elements 1580, 1580a, 1580b can be any conductive element as described with respect to the system 1100.

In some embodiments, disposing of the conductive element 1580 in the openings defined by the second portion 1570a2 of the first isolation layer, and the first portion 5470b1 of the second isolation layer may cause a gap to occur between the second portion of 1570a2 of the first isolation layer and the first portion 1570b1 of the second isolation layer, for example, due to a thickness of the conductive element 1580 being larger than a total thickness of the second portion 1570a2 of the first isolation layer and the first portion 1570b1 of the second isolation layer. In such embodiments, the conductive element 1580 may be sufficiently constrained or under sufficient pressure to compress the conductive element 1580 to reduce its thickness to be substantially equal to the total thickness of the second portion 1570a2 of the first isolation layer and the first portion 1570b1 of the second isolation layer.

In some embodiments, instead of having a conductive element 1580 that is disposed through openings defined in each of the second portion 1570a2 of the first isolation layer and the first portion 1570b1 of the second isolation layer, one of the second portion 1570a2 of the first isolation layer or the first portion 1570b1 of the second isolation layer may be formed from a material that is electron conductive, but electrolyte impermeable (e.g., formed from metals, conductive polymers, carbon, graphite, any other material, or any suitable combination thereof). In such embodiments, the electron conductive but electrolyte impermeable second portion 1570a2 of the first isolation layer or the first portion 1570b1 of the second isolation layer may not define an opening such that conductive element 1580 is disposed in an opening defined in the electronically insulative one of second portion 1570a2 of the first isolation layer or the first portion 1570b1 of the second isolation layer and contacts the corresponding electron conductive but electrolyte impermeable second portion 1570a2 of the first isolation layer or the first portion 1570b1 of the second isolation layer to form a parallel connection therebetween.

In some embodiments, the first electrochemical cell 1500a and the second electrochemical cell 1500b can be electrically coupled through tabs extending from suitable current collectors. For example, a first tab extending from the second current collector 1520a (e.g., a cathode current collector) of the first electrochemical cell 1500a can be coupled to a second tab extending from the second current collector 1520b (e.g., a cathode current collector) of the second electrochemical cell 1500b to couple the first electrochemical cell 1500a to the second electrochemical cell 1500b in parallel. The tabs can be coupled to a voltage source, a voltage measurement point, a diode, a resistor, a transistor, a fuse, or any combination thereof.

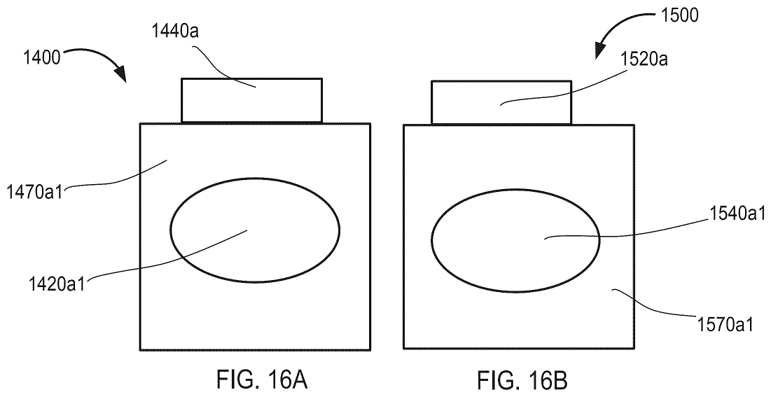

FIG. 16A shows a top view of the electrochemical system 1400 without the conductive element 1480a, as shown in FIG. 14. A portion of the first current collector 1420a1 (e.g., the first cathode current collector) of the first electrochemical cell 1400a can be seen through the respective opening on the first portion 1470a1 of the first isolation layer of the first electrochemical cell 1400a. This design is configured to have a single tab extending from the electrochemical cell system 1400. The portion of the first current collector 1420a1 (i.e., the first cathode current collector) of the first electrochemical cell 1400a can be used as a busbar (e.g., a cathode busbar).

FIG. 16B shows a top view of the electrochemical system 1500, without the conductive element 1580a, as shown in FIG. 15. A portion of the first current collector 1540a1 (e.g., the first anode current collector) of the first electrochemical cell 1500a can be seen through the respective opening on the first portion 1570a1 of the first isolation layer of the first electrochemical cell 1500a. This design is configured to have a single tab extending from the electrochemical system 1500. The portion of the first current collector (i.e., the first anode current collector) 1540a1 of the first electrochemical cell 1500a can be used as a busbar (e.g., an anode busbar).

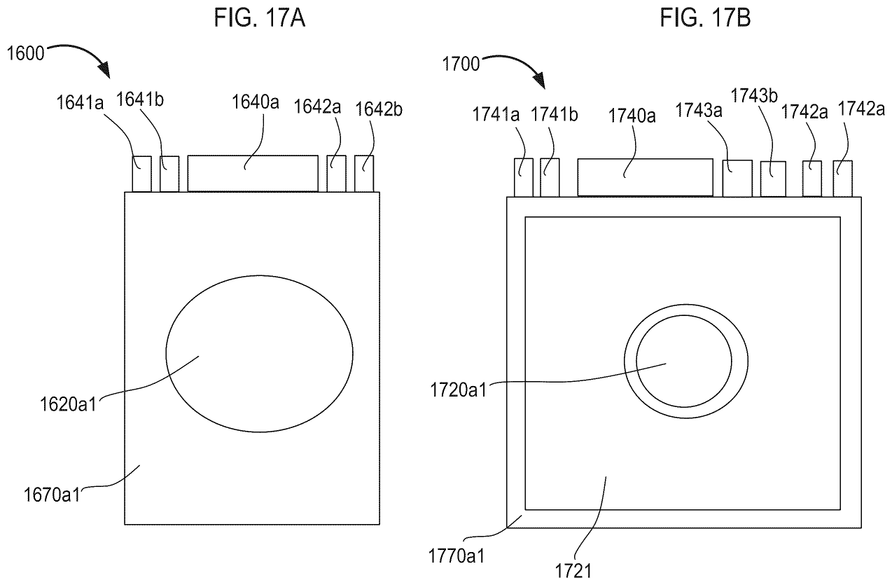

FIGS. 17A is a top view of an electrochemical cell system 1600, according to an embodiment. The electrochemical cell system 1600 is substantially same to the electrochemical cell system 1400 and includes similar features, with a few differences. As shown in FIG. 17A, the electrochemical cell 1600 includes a first portion 1670a1 of a first isolation layer, a first current collector 1620a1 a portion of which is exposed through an opening defined in the first portion 1670a1, and a tab of a double sided second current collector 1640a extending outwards of the first isolation layer 1670a1. The first portion 1670a1 of the first isolation layer, the first current collector 1620a1, and the second current collector 1640a are substantially same to the first portion 1470a1 of the first isolation layer, the first current collector 1420a1, and the second current collector 1440a as described with respect to the electrochemical cell system 1400. Moreover, the electrochemical cell system 1600 includes additional components as described with respect to the system 1400, though not shown in FIG. 16A.

Different from the system 1400 shown in FIG. 14, one or more separators included in the electrochemical system 1600 may also include interlayer(s) for monitoring voltages between various components of the system 1700 (e.g., between one or more anodes or interlayer(s), or cathode(s) or interlayers), for example, to inhibit dendrite formation. Examples of electrochemical cells and systems including such interlayers are described in U.S. patent application Ser. No. 18/543,515, issued Dec. 18, 2023, and entitled, “Systems and Methods for Minimizing and Preventing Dendrite Formation in Electrochemical Cells,” (“the '515 application”), the disclosure of which is hereby incorporated herein by reference in its entirety.

The system 1600 further includes a first set of tabs 1641a and 1641b coupled to the one or more interlayers and anode or cathode, can be configured to detect or measure a voltage change in the interlayer relative to the anode and/or the cathode. Detection of the voltage change allows direct sensing of the dendrite growth before a safety event occurs, as described in the '515 application. Moreover, the system 1600 can also include a second set of tabs 1642a, 1642b for voltage monitoring, or for any other monitoring purpose, for example, monitoring environmental conditions such as moisture, temperature extremes, or electromagnetic interference. In some embodiments, the second set of tabs 1642a, 1642b may be used to monitor various parameters within the battery, such as temperature, voltage, or state of charge, without being affected by external factors that could compromise their accuracy or reliability.

FIG. 17B is a top view of an electrochemical cell system 1700, according to an embodiment. The electrochemical system 1700 is substantially similar to the electrochemical cell system 1600 and includes similar features, with a few differences. As shown in FIG. 17B, the electrochemical cell system 1700 includes a first portion 1770a1 of a first isolation layer, a first current collector 1720a1 a portion of which is exposed through an opening defined in the first portion 1770a1, and a tab of a double sided second current collector 1740a extending outwards of the first isolation layer 1770a1, a first set of tabs 1741a, 1741b for monitoring purposes through an interlayer, and a second set of tabs 1742a, 1742b for voltage monitoring or monitoring of other parameters. The first portion 1770a1 of the first isolation layer, the first current collector 1720a1, the second current collector 1740a, the first set of tabs 1741a, 1741b, and the second set of tabs 1742a, 1742b are substantially similar to the first portion 1670a1 of the first isolation layer, the first current collector 1620a1, the second current collector 1640a, the first set of tabs 1641a, 1641b, and the second set of tabs 1642a, 1642b as described with respect to the electrochemical cell system 1600. Moreover, the electrochemical cell system 1700 includes additional components as described with respect to the system 1600, though not shown in FIG. 17B.

In some embodiments, the heater 1721 may include a conformal coating of an electrically resistive material (e.g., a metal) disposed on the first portion 1770a1 of the first isolation layer. In some embodiments, an opening may be defined in the heater 1721 corresponding to an opening defined in the first portion 1770a1 of the first isolation layer through which the first current collector 1720a1 is accessible. Moreover, a third set of tabs 1743a, 1743b may be electrically coupled to the heater 1721 to allow the heater 1721 to be selectively activated or deactivated to selectively heat the system 1700 (or alternatively cool the system 1700).

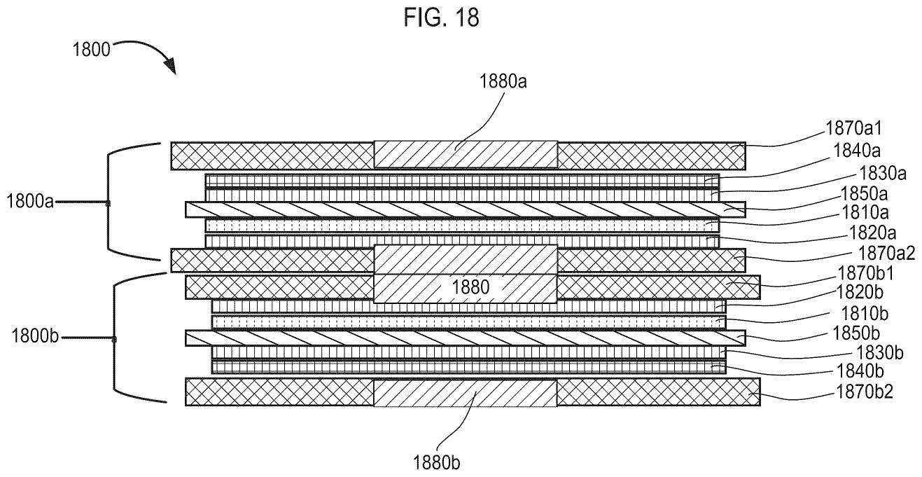

FIG. 18 is a schematic illustration of an electrochemical cell system 1800 including a first electrochemical cell 1800a and a second electrochemical cell 1800b arranged cathode-to-cathode i.e., a cathode current collector 1820a of the first electrochemical cell 1800a is electrically coupled to a cathode current collector 1820b of the second electrochemical cell 1800b in parallel, according to an embodiment. In some embodiments, the first electrochemical cell 1800a and a second electrochemical cell 1800b can be electrically coupled in parallel by direct contact between the respective current collectors (i.e., 1840a and 1840b) under a compressive force, via welding respective tabs of the current collectors, or via a conductive element 1880 (e.g., conductive rubber like or sponge like material) that is in contact with the respective current collectors. In some embodiments, the first electrochemical cell 1800a, the second electrochemical cell 1800b, and the conductive element 1880 can be the substantially same or similar to the first electrochemical cell 1100a, the second electrochemical cell 1100b, and the conductive element as described above with reference to FIG. 11. In some embodiments, the electrochemical cell system 1800 can be substantially same or similar to the system 1200 as described above with respect to FIG. 12.

The first electrochemical cell 1800a includes a first anode 1830a disposed on a first anode current collector 1840a, a first cathode 1810a disposed on a first cathode current collector 1820a, and a first separator 1850a disposed between the first anode 1830a and the first cathode 1810a. The second electrochemical cell 1800b includes a second anode 1830b disposed on a second anode current collector 1840b, a second cathode 1810b disposed on a second cathode current collector 1820b, and a second separator 1850b disposed between the second anode 1830b and the second cathode 1810b.

The first electrochemical cell 1800a may further include a first isolation layer including a first portion 1870a1 and a second portion 1870a2 coupled to each other to form a first volume at least partially enclosing the first electrochemical cell 1800a. Similarly, the second electrochemical cell 1800b also includes a second isolation layer including a first portion 1870b1 and a second portion 1870b2 coupled to each other to form a second volume at least partially enclosing the second electrochemical cell 1800b.

In some embodiments, the second portion 1870a2 of the first isolation layer and the first portion 1870b1 of the second isolation layer which face each other may have corresponding openings (not shown), through which the respective current collectors (i.e., 1820a and 1820b) may be physically and electrically coupled to each other, thereby coupling the first electrochemical cell 1800a and the second electrochemical cell 1800b in parallel. In some embodiments, the first portion 1870a1 of the first isolation layer and the second portion 1870b2 of the second isolation layer, which are located on opposite ends of the system 1800 may also have corresponding openings (not shown).

In some embodiments, the system 1800 can include a plurality of conductive elements (e.g., metal, composite, conductive polymer) 1880a, 1880, 1880b as described with respect to FIG. 11. In some embodiments, the conductive element 1880 can extend through the corresponding openings of the portions 1870a2, and 1870b1 of the isolation layers such that the first electrochemical cell 1800a and the second electrochemical cell 1800b are connected in parallel through the conductive element 1880 that is in contact with the respective current collectors 1820a1820b of first electrochemical cell 1800a and the second electrochemical cell 1800b, respectively.

In some embodiments, the first electrochemical cell 1800a and the second electrochemical cell 1800b can be electrically coupled through tabs extending from suitable current collectors. For example, a first tab extending from the first current collector 1840a of the first electrochemical cell 1800a can be coupled to a second tab extending from the second current collector 1840b of the second electrochemical cell 1800b to couple the first electrochemical cell 1800a to the second electrochemical cell 1800b in parallel. The tabs can be coupled to a voltage source, a voltage measurement point, a diode, a resistor, a transistor, a fuse, or any combination thereof.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell, comprising:
a cathode disposed on a cathode current collector, the cathode current collector including a first layer disposed on the cathode and a second layer disposed on the first layer, the first layer including a first material, and the second layer including a second material different from the first material;
an anode disposed on an anode current collector, the anode current collector including the second material; and
a separator disposed between the cathode and the anode.

2. The electrochemical cell of claim 1, further comprising:
a seal member disposed around a peripheral edge of the electrochemical cell, the seal member coupled to peripheral edges of the second layer of the cathode current collector and to the anode current collector.

3. The electrochemical cell of claim 2, wherein the seal member includes a first portion and a second portion, a portion of the first portion coupled to a corresponding portion of the second portion to form a sealing region.

4. The electrochemical cell of claim 3, wherein peripheral edges of the separator extend at least partially into the sealing region.

5. The electrochemical cell of claim 3, wherein peripheral edges of the cathode current collector and the anode current collector do not extend into the sealing region.

6. The electrochemical cell of claim 1, wherein the first material includes aluminum and the second material includes copper.

7. An electrochemical cell stack, comprising
a first electrochemical cell including the electrochemical cell of claim 1; and
a second electrochemical cell including the electrochemical cell of claim 1,
wherein the second electrochemical cell is disposed on the first electrochemical cell such that the anode current collector of the first electrochemical cell is disposed on the second layer of the cathode current collector of the second electrochemical cell.

8. An electrochemical cell assembly, comprising:
a first electrochemical cell comprising:
a first electrode disposed on a first current collector;
a second electrode disposed on a first side of a second current collector;
a third electrode disposed on a second side of the second current collector, opposite to the first side;
a fourth electrode disposed on a third current collector;
a first separator disposed between the first electrode and the second electrode, and a second separator disposed between the third electrode and the fourth electrode; and
a plurality of seal members, a respective one of the plurality of seal members disposed around the first electrode, the second electrode, the third electrode, and the fourth electrode;
a second electrochemical cell electrically coupled to the first electrochemical cell, the second electrochemical cell comprising:
a first electrode disposed on a first current collector;
a second electrode disposed on a first side of a second current collector;
a third electrode disposed on a second side of the second current collector, opposite to the first side;
a fourth electrode disposed on a third current collector;
a first separator disposed between the first electrode and the second electrode, and a second separator disposed between the third electrode and the fourth electrode; and
a plurality of seal members, a respective one of the plurality of seal members disposed around the first electrode, the second electrode, the third electrode, and the fourth electrode.

9. The electrochemical cell assembly of claim 8, further comprising:
at least one of an insulation layer or a heating layer disposed between the first electrochemical cell and the second electrochemical cell.

10. The electrochemical cell assembly of claim 9, wherein:
the fourth electrode of the first electrochemical cell includes an anode, and the first electrode of the second electrochemical cell includes a cathode, and
the at least one of the insulation layer or the heating layer is disposed between the third current collector of the first electrochemical cell and the first current collector of the second electrochemical cell.

11. The electrochemical cell assembly of claim 8, wherein:
the fourth electrode of the first electrochemical cell includes an anode, and the first electrode of the second electrochemical cell includes a cathode,
the third current collector of the first electrochemical cell disposed on the first current collector of the second electrochemical cell, and
the third current collector of the first electrochemical cell including a first material, and the first current collector of the second electrochemical cell including a second material different from the first material.

12. The electrochemical cell assembly of claim 11, wherein the first material includes copper and the second material includes aluminum.

13. The electrochemical cell assembly of claim 11, further comprising:
at least one of an insulation layer or a heating layer disposed between the third current collector of the first electrochemical cell and the first current collector of the second electrochemical cell.

14. The electrochemical cell assembly claim 8, wherein:
the fourth electrode of the first electrochemical cell and the first electrode of the second electrochemical cell includes an anode,
the third current collector of the first electrochemical cell is disposed on the first current collector of the second electrochemical cell, and
the third current collector of the first electrochemical cell and the first current collector of the second electrochemical cell include the same material.

15. The electrochemical cell of claim 8, wherein:
the second and the third electrodes of the first electrochemical cell include a cathode and the second current collector of the first electrochemical cell includes a cathode current collector, and
the second current collector of the first electrochemical cell is coupled to the first current collector of the second electrochemical cell to electronically couple the first electrochemical cell to the second electrochemical cell in series.

16. The electrochemical cell of claim 8, wherein:
the second and the third electrodes of each of the first and second electrochemical cells include a cathode and the second current collector of each of the first and second electrochemical cells includes a cathode current collector, and
the second current collector of the first electrochemical cell is coupled to the second current collector of the second electrochemical cell to electronically couple the first electrochemical cell to the second electrochemical cell in parallel.

17. An electrochemical cell system, comprising;
a first electrochemical cell, comprising: a first anode current collector, a first anode disposed on the first anode current collector, a first cathode current collector, a first cathode disposed on the first cathode current collector, a first separator disposed between the first anode and the first cathode; and
a second electrochemical cell, comprising: a second anode, a second cathode current collector, a second cathode disposed on the second cathode current collector, a second separator disposed between the second anode and the second cathode.

18. The electrochemical cell system of claim 17, further comprising a first isolation layer at least partially enclosing the first electrochemical, and a second isolation layer at least partially enclosing the second electrochemical cell to fluidically isolate the first electrochemical cell from the second electrochemical cell.

19. The electrochemical cell system of claim 18, wherein:
the first anode current collector is electrically coupled to the second cathode current collector such that the first electrochemical cell is coupled to the second electrochemical cell in series, and
each of the first isolation layer and the second isolation layer define corresponding openings, the first anode current collector electrically coupled to the second cathode current collector through the corresponding openings.

20. The electrochemical cell system of claim 19, further comprising:
a conductive element disposed through the corresponding openings to contact and electrically couple the first anode current collector to the second cathode current collector.

21. The electrochemical cell system of claim 20, wherein the conductive element includes a conductive rubber or a conductive sponge.

22. The electrochemical cell system of claim 18, wherein:
the first cathode current collector is electrically coupled to the second cathode current collector such that the first electrochemical cell is coupled to the second electrochemical cell in parallel, and
each of the first isolation layer and the second isolation layer define corresponding openings, the first cathode current collector electrically coupled to the second cathode current collector through the corresponding openings.

23. The electrochemical cell system of claim 18, wherein:
each of the first isolation layer and the second isolation layer define corresponding openings,
wherein the first cathode is disposed on a first side of the first cathode current collector, and the second anode is disposed on a second side of the first cathode current collector opposite the first side through the corresponding openings.

24. The electrochemical cell system of claim 23, further comprising:
a conductive element disposed through the corresponding openings to contact and electrically couple the first anode current collector to the second cathode current collector.

25. The electrochemical cell system of claim 24, wherein the conductive element includes a conductive rubber or a conductive sponge.
